(19) United States
(12) Patent Application Publication
(10) Pub. No.: US 2004/0191744 A1
(43) Pub. Date: Sep. 30, 2004

(54) Electronic training systems and methods

(75) Inventor: Raouf A. Guirguis, Vienna, VA (US)

Correspondence Address: ROTHWELL, FIGG, ERNST & MANBECK, P.C., 1425 K STREET, N.W., SUITE 800, WASHINGTON, DC, 20005, US

(73) Assignee: La Mina Inc., Arlington, VA

(21) Appl. No.: 10/669,897

(22) Filed: Sep. 25, 2003

Related U.S. Application Data
(60) Provisional application No. 60/413,138, filed on Sep. 25, 2002.

(51) Int. Cl. G09B 7/00; G09B 3/00

(52) U.S. Cl. 434/322

(57) ABSTRACT

A number of new electronic training systems and methods are disclosed. In some exemplary embodiments, an instructor can control the environment of a student presented to the student via a student computer, while maintaining real life communication between the instructor and the student via audio and/or video communication(s).

The present application claims priority to provisional application serial No. 60/413,138 entitled Multi-Phase Training Simulation Modular System filed on Sep. 25, 2002, the entire disclosure of which is incorporated herein by reference.

### BACKGROUND

1. Field of the Invention

The present invention relates generally to education and training and exemplary embodiments relate more particularly to electronic training systems and methods for assisting instruction of students.

2. Background Discussion

Traditional instructor based learning is well established and, in many cases, a very effective means of learning. But unfortunately, it may not be possible in some cases because of, e.g., a lack of or shortage of highly skilled trainers. Usually, it is cost prohibitive and requires a significant amount of time to line-up the resources to achieve the desired results. In some cases, this may even result in a potential bodily harm and/or problematic deficiencies in capabilities—such as, e.g., in some instances involving cultural training and/or visiting a foreign country.

One substantial disadvantage in the use of instructor based training is the dependency on the skills and style of the human operator (i.e., the instructor) which may fluctuate significantly from one instructor to another. As a result, there are insufficient quality controls or ways to standardize the training delivery due to inconsistencies among the human operators. More recently, a need has arisen to isolate students from an instructor's non-teaching characteristics (such as, e.g., cultural and/or religious background) while utilizing the instructor's teaching or training (such as, e.g., language training) skills. For example, in cases such as in the war against terrorism or such as in, e.g., the war in Iraq, Kosovo or the like), the student's may be influenced due to the instructor's background and culture. Accordingly, this may impact the student's judgment which may even endanger his and/or her life at a time of crisis.

Although an interaction between the instructor and the student may be necessary to gain insights into the actual situation, uncontrolled interaction may impact and impair the judgment of the student(s) which may result in a life threatening situations. There is a need to ensure the proper equalization of the knowledge given to the students while standardizing the interaction between the students and the instructor.

Another disadvantage is the low availability of instructors. In today's culture, we often need a large number of instructors in a short period of time. For example, this may occur during the preparation for world events such as the Olympics in a foreign countries, wars, disaster relief issues, World Bank projects and/or in various crisis situations. As a result, it is often impossible to fulfill the need because of a lack of appropriate instructors.

On the other hand, current Internet based distance learning has very limited capabilities. Most of the existing computer based training systems (CBTs) behave like books or tape players. Existing systems have substantially no intelligence in teaching because, among other things, for example:

The existing systems do not appropriately adjust to the needs of special students;

The existing software is too boring to run through more than one time (e.g., it typically repeats itself in its entirety);

The existing software does not have the proper quality of audio and/or video files due to, e.g., issues related to a) distribution on CD (e.g., limited by sizes of CDs) and/or b) real time distribution over the Internet (e.g., which is limited by the bandwidth of the network).

These and/or other limitations make the existing processes of learning from a computer based training (CBT) system difficult to use. Some existing systems and methods include the following.

U.S. Pat. No. 6,608,992 entitled “Web-Based Education” which indicates, among other things, that:

“The present invention [of U.S. Pat. No. 6,608,992] concerns an educational approach wherein a web based, role focused framework provides a graphical user interface from which blended (web-based, other computer based (CDROM), webroom and classroom) learning activities are deployed and tracked to regionally based audiences. The framework is arranged into five basic modules: industry, solution, processes, skill and tools. Private lessons are first given to students through web sites (modules of the framework). Then the students attend a class, but through a web conference, without actually attending a class room. In the webroom, a facilitator explains and elaborates the principles set forth in the private lessons and also provides guided practice of the application of the skill/concept on-line. In some cases the private lesson and webroom provide the prework necessary to an actual live simulation session held in a traditional classroom setting. This approach shortens the amount of face to face time required to master a skill, process or concept.” See Paragraph 1 of the Description.

U.S. Pat. No. 6,470,170 entitled “System and Method for Interactive Distance Learning and Examination Training” which indicates, among other things, that:

“The present invention [in U.S. Pat. No. 6,470,170] provides a system of interactive distance learning and examination training comprising a website having a graphical user interface; an archival training database accessible from said web site, said training database containing a menu of levels of practice examinations accessible through said graphical user interface; a module interface means which notifies a teacher or artificial intelligence module that a student has logged onto said website; a mean for selection by said student of one of said examinations from said practice examination; a means to enable a student to provide an answer to said examination through said graphical user interface; a means for providing selectable on line student help options available to a student after an examination has commenced; a means for evaluation of student answers; and a means for generating performance displays of said student the examination selected by said student and a database for storing information associated with each examination taken by said student.” See Summary of Invention.

U.S. Pat. No. 5,974,446 entitled “Internet Based Distance Learning System for Communicating Between Server and Clients Wherein Clients Communicate with Each Other or With Teacher Using Different Communication Techniques Via Common User Interface” which indicates, among other things, that:

“The present invention [of U.S. Pat. No. 5,974,446] relates to the Internet (or similar wide access communication systems hereinafter generically embraced by the term “Internet”) providing facility for communication, including information sharing and dialog, including real-time dialog, amongst widely geographically distant and separated computer users; being more particularly directed to the enabling of information and dialog or chatter networking amongst such users as for the purpose of providing user selected information on various topics from a central file server to the user stations and for enabling the users to network with other users also interested in the same topic(s) and with the server“thereby providing for common, and where desired, real time networking of common Internet users and user groups region-wide, nation-wide and indeed world-wide. An important application is for distance teaching and learning and exchange, and for providing a virtual classroom accessible in real-time by geographically separated users, and with real-time interchange simulating an actual single classroom for all.” See Paragraph 1 of the Description.

U.S. Pat. No. 6,471,521 entitled “System for implementing collaborative training and online learning over a computer network and related techniques” which indicates, among other things, that:

“In accordance with the present invention [of U.S. Pat. No. 6,471,521], a system for implementing a collaborative training and learning system on a computer system accessible to a plurality of online users through a computer network includes: (a) means for displaying at a user site at least one template or web page which includes a question field, an answer field, a discussion field, a rationale field and a references field, (b) means for inputting user-data including a user-defined item to be included in a predetermined area of the template, (c) means for storing the user-data in a predetermined field of a database, (d) means for retrieving the user-data from the database and for displaying the template and the user-data on a display of the computer system, and (e) means for collaborating with other users of the system. With this particular arrangement, a learning system is provided which may be used to provide team-based learning over a computer network. Each user may connect to the learning system through a larger network, such as the Internet. The learning system includes at least one server computer which can be accessed by the online users. In a exemplary embodiment, the online users remain anonymous (i.e., their true identity is shielded from other users).” See Summary of Invention.

In addition, other existing systems and/or methods include systems of the following entities: ALTA LANGUAGE SERVICES (see http://www.altalang.com/); FAIRFIELD LANGUAGE TECHNOLOGIES (see http://www.RosettaStone.com); TRANSPARENT LANGUAGE (see http://www.transparentlanguage.com); and AURALOG (see http://www.auralog.com/).

While a variety of systems and methods are known, there remains a need exists for improved electronic training systems and methods that can overcome, among other things, various limitations of existing systems.

### SUMMARY

Various embodiments of the present invention can significantly improve upon existing systems and methods. In some exemplary embodiments of the present invention, one or more of any above and/or other problems with existing systems can be overcome.

According to some embodiments of the invention, a training system is provided that includes: a plurality of student computers configured to present course content to students; at least one instructor computer networked with the plurality of student computers, the instructor computer and the plurality of student computers being configured to enable operation commands to be sent from the instructor computer to the student computer; whereby, upon receipt of said operation commands, said student computers are modified and/or changed on said instructor commands; the student computers and the at least one instructor computer each including audio and/or video receivers and transmitters to enable real time communication between the instructor and the student. In some illustrative embodiments, upon receipt of the operation commands, the student computers enable the course content presented to the respective student to be modified based on the instructor commands. The terminology training used herein encompasses, among other things, training, teaching and learning. In exemplary embodiments, the training system can be used, e.g., for remote training, remote teaching and/or remote learning).

According to other embodiments of the invention, a training system is provided that includes: a plurality of student devices, the student devices including course content stored thereon in digital data storage; at least one instructor operable computer networked with the plurality of student devices, the instructor operable computer and the plurality of student devices being configured to enable operation commands to be sent from the instructor computer to the student devices; whereby, upon receipt of the operation commands, the student devices enable the course content presented to the respective student to be modified based on the instructor commands. In some embodiments, the student devices are programmed to display course content to students without requiring a network communication over a public network and without requiring loading of software onto the devices due to pre-storage of the course content.

According to other embodiments, a training system is provided that includes: a central server containing course management software; a plurality of student devices, the student devices including course content downloadable from the central server; at least one instructor operable computer networked with each of the plurality of student devices and the central server, the instructor operable computer and the plurality of student devices being configured to enable operation commands to be sent from the instructor operable computer to the student devices; whereby, upon receipt of the operation commands, the student devices enable the course content presented to the respective student to be modified based on the instructor commands.

According to other embodiments, a multi-component training system is provided that includes: a central server containing course management software; a plurality of student computers; at least some of the student computers including pre-programmed devices including course content downloaded from the central server; at least some of the student computers being located in an on-site location; at least some of the student computers being transported to a remote location distant to the on-site location; whereby the student computers in d) and e) above can be used in different phases of student training.

According to other embodiments of the invention, a method for facilitating instructor training of students includes: having students access course content via a plurality of student computers configured to present course content to students; modifying the course content presented to at least one student on at least one of the student computers based on commands sent from an instructor computer networked with the plurality of student computers; having the at least one student communicate remotely with the instructor in substantially real time audio or video.

According to other embodiments of the invention, a method is provided that includes: controlling a course presentation to a remote student via a student computer by commands sent via a network from an instructor; and conducting real life communication between the instructor and the student via audio and video communication.

According to other embodiments of the invention, a course training console is provided that includes: a computer system having a student console with a monitor for displaying course lesson information, wherein the course lesson information is pre-stored in digital data storage prior to displaying course lesson information; the console including at least one audio/video receiver and transmitter configured to provide real time feedback from a remote instructor.

In some implementations, one or more of the embodiments described herein can be modified to include, e.g., progress monitoring tools, student tracking tools and/or reporting tools. In some implementations, communications (such as, e.g., audio, video, text, etc.) can include a MICROSOFT NETMEETING integration with customer interface programming, whereby video communications, audio communications, chat room communications, white board communications (including, e.g., shared text, images and/or the like) and/or file transfer protocol (FTP) capability can be provided to the training, learning and teaching tools or as a toolbox.

The above and/or other aspects, features and/or advantages of various embodiments will be further appreciated in view of the following description in conjunction with the accompanying figures. Various embodiments can include and/or exclude different aspects, features and/or advantages. In addition, various embodiments can combine one or more aspect or feature from other embodiments. The descriptions of aspects, features and/or advantages of particular embodiments should not be construed as limiting other embodiments or the claims.

### BRIEF DESCRIPTION OF THE DRAWINGS

The accompanying figures are provided by way of example, without limiting the broad scope of the invention or various other embodiments. In the figures, like reference numerals designate like or similar parts, wherein:

FIG. 1 is a schematic diagram showing system components according to some illustrative embodiments;

FIG. 2 is another schematic diagram showing system components according to some illustrative embodiments;

FIG. 3 is another schematic diagram showing system components according to some illustrative embodiments;

FIG. 4 is another schematic diagram showing system components according to some illustrative embodiments;

FIG. 5 is an illustrative graphical user interface according to some illustrative embodiments;

FIG. 6 is another schematic diagram showing system components according to some illustrative embodiments;

FIG. 7 is another schematic diagram showing system components according to some illustrative embodiments;

FIG. 8 is another schematic diagram showing system components according to some illustrative embodiments;

FIGS. 9, 10-11 and 12-14 are sequence diagrams showing illustrative use cases for browse courses, register courses and take courses, respectively, according to some illustrative embodiments;

FIGS. 15(A)-15(C) are illustrative interface screen shots according to some illustrative embodiments;

FIG. 16 shows a variety of views of an illustrative console for a training simulation module in some illustrative embodiments;

FIG. 17 is a schematic diagram showing system components related according to some illustrative embodiments including a content generation tool;

FIGS. 18-20 are illustrative interface screen shots according to some illustrative embodiments;

FIGS. 21-24 are illustrative architectural diagrams depicting four optional phases, phases 1-4, respectively, according to some illustrative embodiments;

FIG. 25(A) is a schematic diagram demonstrating changes in instructor and computer involving in some illustrative embodiments;

FIG. 25(B) is a schematic diagram demonstrating adaptability of order of presentation of modules within a lesson according to some illustrative embodiments;

FIG. 26(A) and 26(B) are illustrative interface screen shots according to some illustrative embodiments;

FIG. 26(C) is an illustrative directories hierarchy in some illustrative embodiments;

FIG. 26(D) is an illustrative use diagram according to some illustrative embodiments including a content generation tool;

FIGS. 27(A)-27(B) and 28(A)-28(B) are illustrative interface screen shots according to some illustrative embodiments;

FIG. 29 is an illustrative use diagram according to some illustrative embodiments including a tracking tool;

FIGS. 30(A)-30(D), 31(A)-31(D) and 32 are illustrative interface screen shots according to some illustrative embodiments.

FIG. 33 is a schematic diagram showing a plurality of instruction methodologies that could be employed in some illustrative embodiments.

### DESCRIPTION OF THE PREFERRED EMBODIMENTS

While the present invention may be embodied in many different forms, a number of illustrative embodiments are described herein with the understanding that the present disclosure is to be considered as providing examples of various principles of the invention and such examples are not intended to limit the invention to exemplary or preferred embodiments described herein and/or illustrated herein.

In some of the exemplary embodiments, a system is provided that includes the following components: 1) system hardware, including, e.g., computer devices (CPU, monitors, speakers, microphone, and other devices); 2) a management system which provides, e.g., user interfaces for the processes; and 3) an integrated communication software application that simulates a conventional classroom environment for student-instructor's interaction.

In exemplary embodiments, a system is provided that serves as a remote learning platform, providing all the functionalities of a typical e-learning management system, with enhanced remote learning and teaching processes to allow real-time instructor-led training, progress monitoring, dynamic course content delivery, and technology-assisted learning. Some exemplary embodiments can provide, e.g., a unique focus on the remote learning and teaching process based on a unique system design, real-time environment simulation, and custom software for tracking, content delivery, and learning management. In brief, the preferred embodiments can provide a “learning integration” solution.

Various embodiments of the invention can be employed in a variety of applications. A few illustrative and non-limiting examples include language training, workplace skill training, various courses (such as, e.g., high school, college and/or other courses), translation applications, interpretation applications and various other applications.

As described herein, certain exemplary embodiments of the invention can be implemented using a plurality of computer(s) which depending on circumstances (as described below) may communicate over one or more network of computer(s) communicate, such as, e.g., a local area network (LAN), a wide area network (WAN), a public network, such as, e.g., the Internet, and/or another network. In various embodiments, as described herein, one or more server(s), client computer(s), application computer(s) and/or other computer(s) can be utilized to implement one or more aspect of the invention. Illustrative computers can include, e.g.: a central processing unit; memory (e.g., RAM, etc.); digital data storage (e.g., hard drives, etc.); input/output ports (e.g., parallel and/or serial ports, etc.); data entry devices (e.g., key boards, etc.); etc. Client computers may contain, in some embodiments, browser software for interacting with the server(s), such as, for example, using hypertext transfer protocol (HTTP) to make requests of the server(s) via the Internet or the like. In addition, various computers can include other protocols as needed to effect communications described herein, such as, e.g., file transfer protocol (FTP) for transferring, uploading and/or downloading files and/or the like.

In any of the various embodiments, communications between computers and/or between networks of computers can use any form of communication, such as, e.g., wireless communications (such as, e.g., using electromagnetic waves), wired communications, etc. In some embodiments, communications can include the use of wireless digital transmitters and receivers. In some exemplary embodiments, wireless transmissions can include transmissions to satellite(s) in orbit around the earth, such as, e.g., using satellite broadcasting to digital receivers, such as, e.g., the devices manufactured by WORLDSPACE: AFG Digital Receiver WSSR-11 (See http:www.worldspace.com).

In some exemplary embodiments, the system utilizes relational databases, such as, e.g., employing a relational database management system (RDBMS) program to create, update and/or administer a relational database. The RDBMS may take Structured Query Language (SQL) statements entered by a user or contained in an application program and create, updates and/or provides access to database(s). Some illustrative RDBMS's include ORACLE's database product line and IBM's DB2 product line. In some illustrative embodiments, one or more client computer can be provided, such as, e.g., a LAN-based system. The client computer(s) can include an appropriate operating system, such as, for example, WINDOWS NT or another system. In exemplary embodiments, as described herein, the system is adapted to provide an object based graphical user interface (GUI) on one or more client computer.

In some illustrative embodiments, process steps can be carried out via computers by way of their central processing unit (CPU), which can communicate with a set of input/output (I/O) device(s) over a bus. The I/O devices can include, for example, a keyboard, mouse, video monitor, printer, and/or other devices. The CPU can communicate with a computer readable medium (e.g., conventional volatile or non-volatile data storage devices) (hereafter “memory”) over the bus. The interaction between a CPU, I/O devices, a bus, and a memory can be like that known in the art. Memory can include, for example, data and can also store software. The software can include a number of modules for implementing the steps of processes, such as computer implemented steps of the processes described herein. Conventional programming techniques may be used to implement these modules.

In some embodiments, the various methods described herein may be implemented in computer program products for use with a computer system. This implementation may, for example, include a series of computer instructions fixed on a computer readable medium (e.g., a diskette, a CD-ROM, ROM or the like) or transmittable to a computer system via an interface device, such as a modem or the like. The medium may be substantially tangible (e.g., communication lines) and/or substantially intangible (e.g., wireless media using microwave, light, infrared, etc.). The computer instructions can be written in various programming languages and/or can be stored in memory device(s), such as semiconductor devices (e.g., chips or circuits), magnetic devices, optical devices and/or other memory devices. In the various embodiments, the transmission may use any appropriate communications technology.

Illustrative Architectural Components

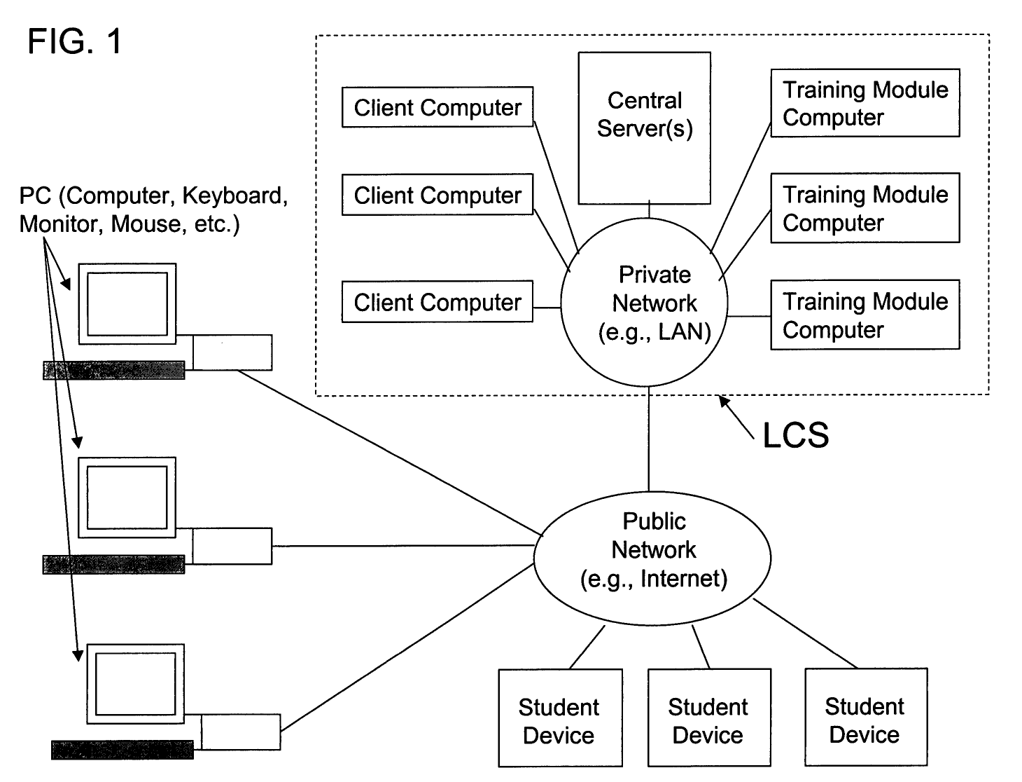

FIG. 1 illustrates components that can be employed in some illustrative embodiments. While some illustrative embodiments may employ most or all of these components, it should be understood based on this disclosure that the various embodiments do not require each of these components. For example, certain computers and/or the like may be omitted in some embodiments. As another example, only some (or even one) of the “phases” of training (described below) which phases may preferably utilize certain components may be employed in some embodiments. Similarly, the components described can be utilized to implement other phases or forms of training as would appreciated based on this disclosure. Thus, while preferred overall systems are shown and described, it should be understood based on this disclosure that various embodiments can incorporate portions of these overall systems and that such are not required in practicing various embodiments.

In this regard, FIG. 1 shows a learning center system which is preferably managed and controlled by an entity providing the training (such as, e.g., a teaching institution or other entity). However, in various embodiments, components, such as, e.g., web servers, application servers, etc., can be managed and controlled by another entity (such as, e.g., an ISP or another computer service provider). In some embodiments, some or all of these components within the region LCS can be connected via a private network, such as, e.g., a local area network (LAN), an Intranet or the like. In other embodiments, some or all of these components within the region LCS can be connected via a public network, a virtual private network or via another means.

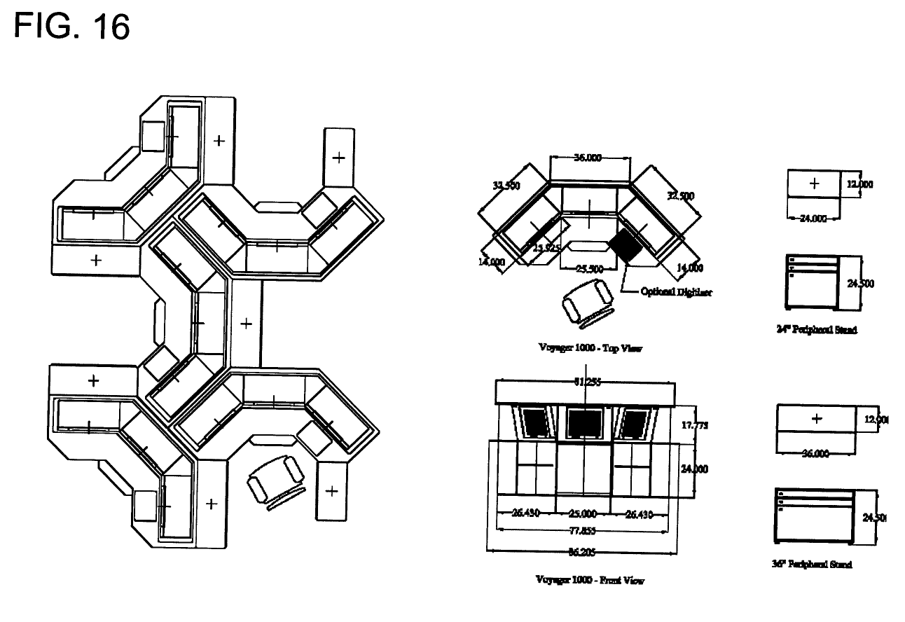

In some embodiments, as shown, a plurality of training module computers (while the number of such computers and other computers depicted can vary widely, three are shown for illustrative purposes only) can be used to provide in-class training to students (such as, e.g., at an on-site location owned or used by the teaching institution). In some embodiments, the training module computers can include features similar to that of the in class computer devices shown in FIGS. 16 and 21 and used in phase 2. In some embodiments, the training module computers can be located on-site at a training entity location (such as, e.g., in a region LCS under the management and/or control of the training entity). In other embodiments, the training module computers or some of the training module computers can be located off-site from the training entity, such as, e.g., upon installation at a client site, such as, e.g., at a corporate client site. In such a case, the client site computers may communicate via a network, such as, e.g., the Internet with the central server(s) which may be on-site at the training entity or otherwise distant from the client site.

In some embodiments, various other on-site client computers can be provided in the region LCS, as shown, for use as instructor computers (such as, e.g., described below), as computers for system administrators and/or as supplemental computers for student access and/or the like. In some exemplary embodiments, these other computers can include standard desktop and/or laptop and/or other computers, including, e.g., keyboards, displays, monitors, hand-operated GUI pointer devices (e.g., mice), etc.

In some embodiments, the training entity can provide substantially only on-site computer training, while in some embodiments, the training entity can provide substantially only off-site computer training, while in some exemplary embodiments (as described herein), the training entity can provide both on-site and off-site computer training.

Illustrative off-site computer devices can include, e.g., student devices, as shown in FIG. 1. In this regard, the student devices are preferably distributed to the students by the training entity or by another entity under the direction or control of the training entity. In some embodiments, the student devices can be owned by the training entity, while in other embodiments, the student devices can be purchased by the students. In some embodiments, the student devices can be distributed to students and used for any classes offered by the training entity. In some embodiments, the student can return the devices to the training institution for technology upgrades and/or modifications and/or to adapt the device for other classes of the entity (either periodically, such as, e.g., after a course period [e.g., a seminar, a semester, or the like] is completed and/or on an as-needed basis). In some embodiments, the student devices can include portable components, such as, e.g., similar to lap top computers, existing e-books and/or the like. In some embodiments, the student devices can include features as described below with reference to, e.g., FIG. 22 and phase 3 described below. As shown, the student devices can preferably communicate with the central server via a public network, such as, e.g., via the Internet (for certain purposes as described below).

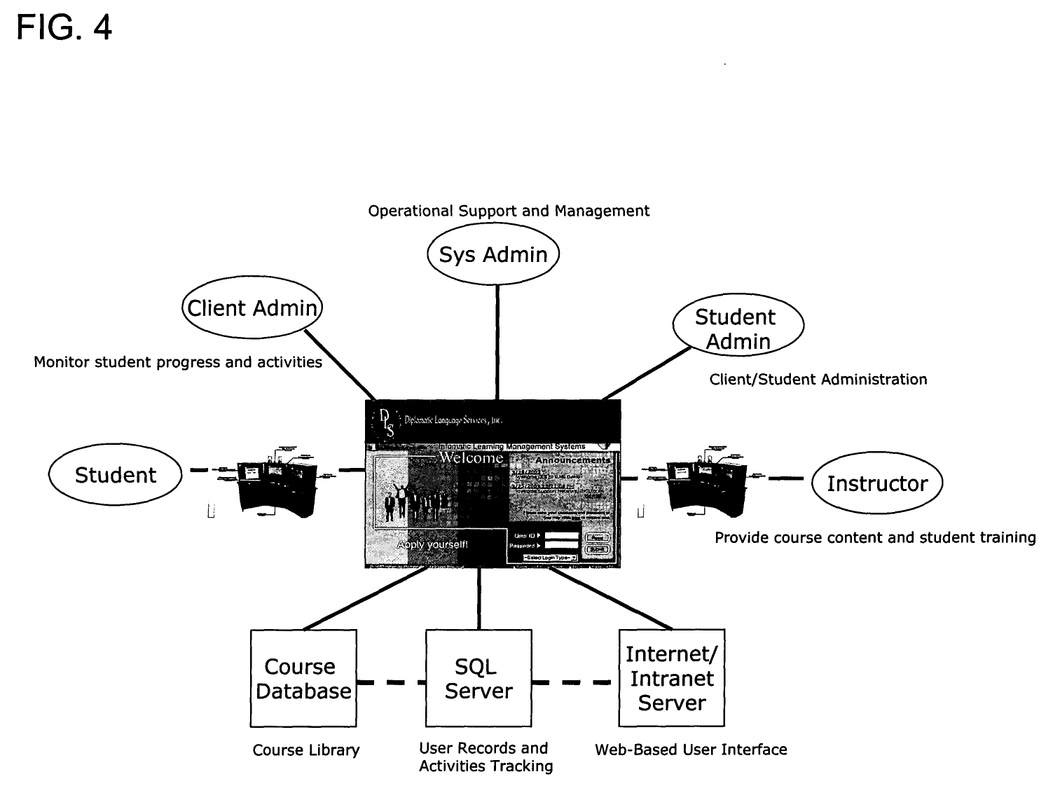

Other illustrative off-site computer devices can include, e.g., personal computers (PCs) as shown, and/or other computer devices, such as, e.g., lap top computers, personal digital assistants and/or other computer devices. As shown, these other illustrative off-site computer devices (which like other components can be optionally incorporated into the system) can be made to communicate with the system remotely via a public network such as, e.g., the Internet or the like. In some embodiments, such computers can be used by instructors or the like as instructor computers (such as, e.g., to achieve functionality described below), as system administrator computers and/or as supplemental computers for student access and/or the like. In this regard, in some embodiments, one or more functional component of the system can be accessed by one or more type of user (such as, e.g., upon appropriate entry of a user ID and password) on-line over the Internet or the like (see, e.g., the embodiment shown in FIG. 4, wherein each user can preferably be presented with different functionality upon appropriate user identification or authentication).

In some embodiments, although not shown, communications between computers within the region LCS could also and/or alternatively be conducted via a public network, such as, e.g., the Internet, as long as adequate security measures are employed (such as, e.g., user ID and password protection, creation of a virtual private network [VPN] and/or the like).

Illustrative Three-Tier Architectural Model

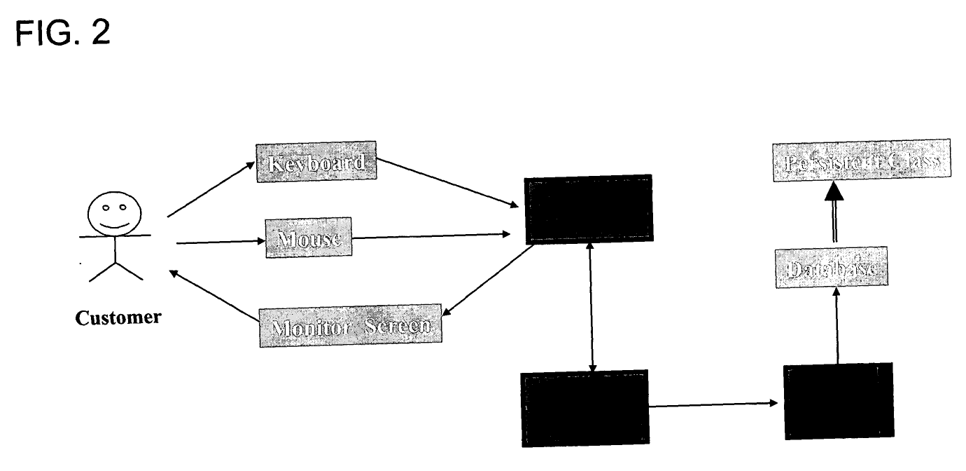

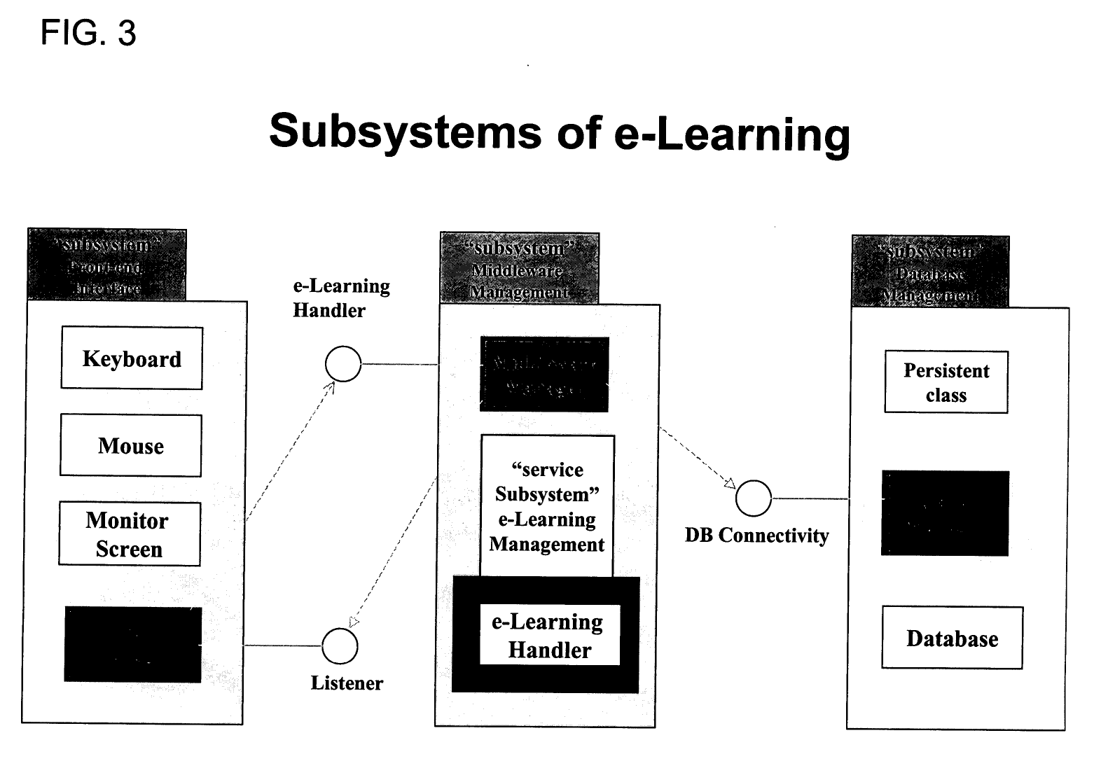

With reference to FIGS. 2 and 3, a substantially three-tier architectural model may be employed in the implementation of some embodiments of the present invention. In this regard, some embodiments can include three nodes:

1. A client node (such as, e.g., a student computer): This node may include, e.g., browser software or component (.exe file) or the like based on a client computer or the like (which computer can, e.g., be located on site in some embodiments).

2. An application server node: This node may include, e.g., JRUN application server software or other application server software on a server or computer (which can, e.g., be located on-site in some embodiments). In addition, in some preferred embodiments, such as, e.g., in some implementations of embodiments shown in FIG. 4, discussed below, applications could be developed using various other tools, such as, e.g., JAVA, MS VISUAL STUDIO.NET and ASP programming tools (e.g., for dynamic Web Pages, etc.).

3. A database server node: This node may include, e.g., an open source relational database management system (RDBMS) that uses Structured Query Language (SQL) for adding, accessing, and/or processing data in a database, such as, e.g. MySQL or the like (which can, e.g., be located on site in some embodiments).

In some exemplary embodiments, functionality of the system is distributed across these nodes, such as, e.g., including that:

1. A front end interface subsystem (e.g., program) and/or client manager system is deployed on a client node;

2. A middleware management system is deployed on an application server node;

3. A database management system is deployed on the database server node.

By way of example, the front end interface subsystem and/or client manager system can be deployed on the various computers shown in FIG. 1, including especially, for example, the training module computers and the student devices. As another example, the middleware manager and/or the database manager can be deployed on the central server(s) shown in FIG. 1 (which can include the same or separate computer devices).

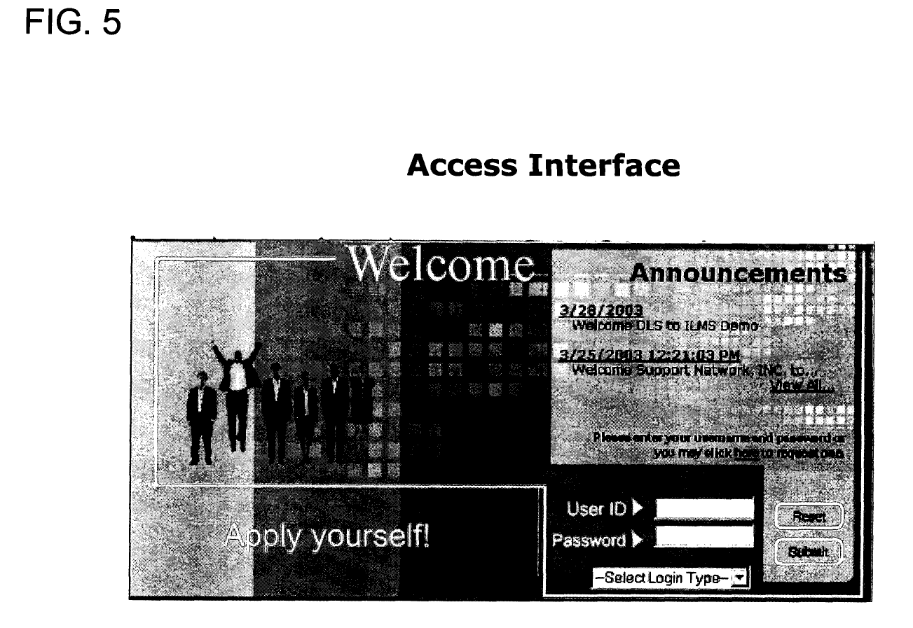

FIG. 4 is a structural diagram that shows illustrative architecture and functionality that could be implemented in some preferred embodiments. In such embodiments, an illustrative “welcome” page (shown enlarged in FIG. 5) can be provided as a front end interface which can be accessed, as shown, by each Student (who, e.g., receive training via interaction with the instructor), Client Administration (who, e.g., monitor student progress and activities), System Administration (who, e.g., provide operational support and management), Student Administration (who, e.g., provide client/student administration), and/or by the Instructor (who, e.g., provides course content, student training and the like). As illustrated, this front end interface can be provided, e.g., via an Intranet and/or an Intranet or the like using an SQL server or the like and a course database. Thus, in exemplary embodiments (as described above), the system allows access from within the training entity's LAN and/or Intranet environment and via a public network such as, e.g., the Internet. Embodiments like that shown in FIG. 4 can have some increased advantages by providing, e.g., a secure Internet or the like based access to a) course content and/or b) system functionality based on, e.g., system identification and/or authentication of users. For example, while some computers can include course content pre-loaded thereon, in preferred embodiments, course content could also and/or alternatively be accessed via a secure Internet or the like connection.

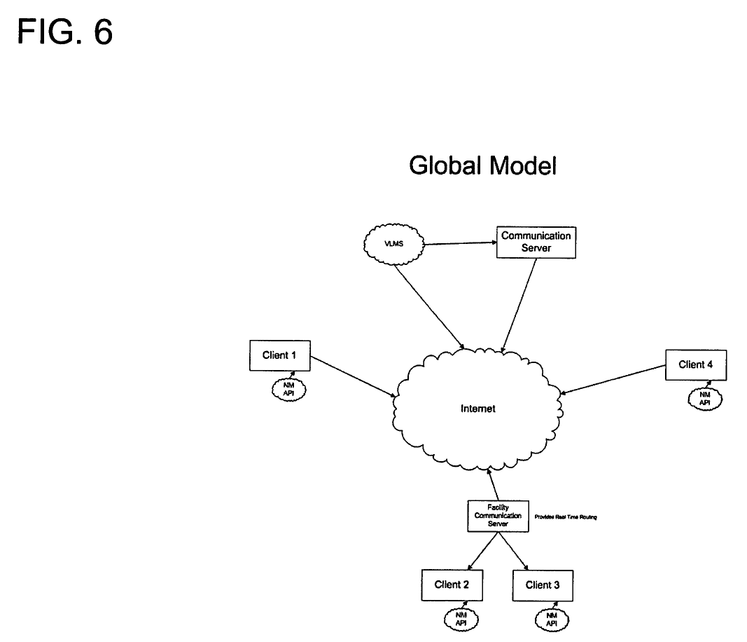

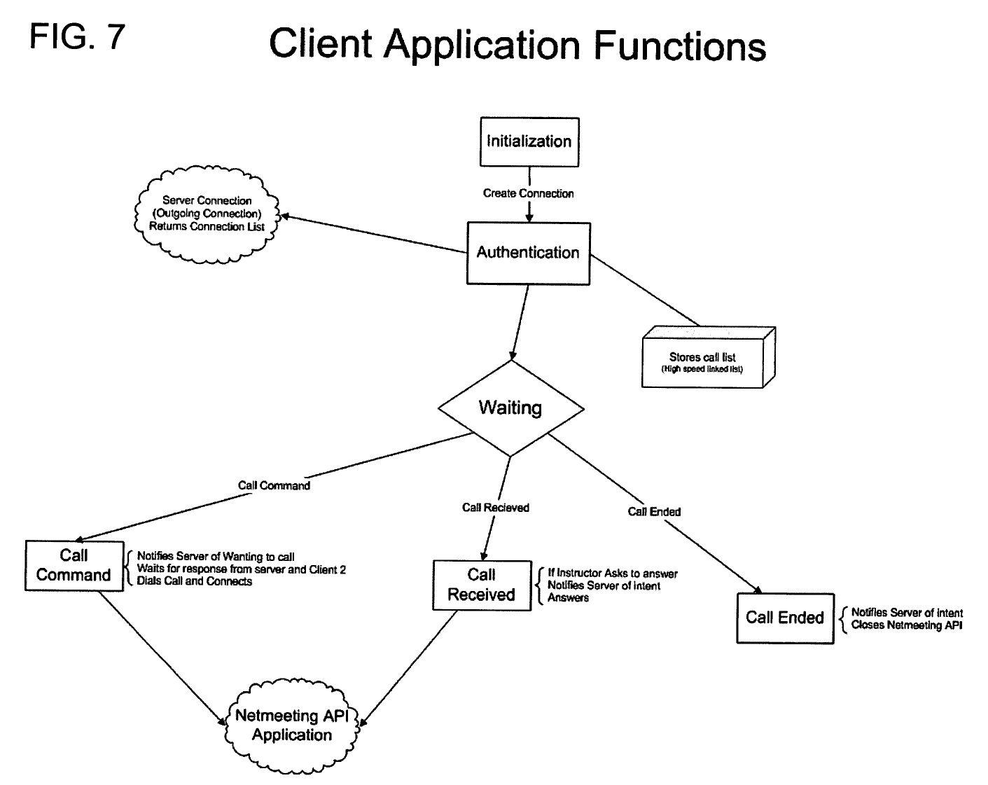

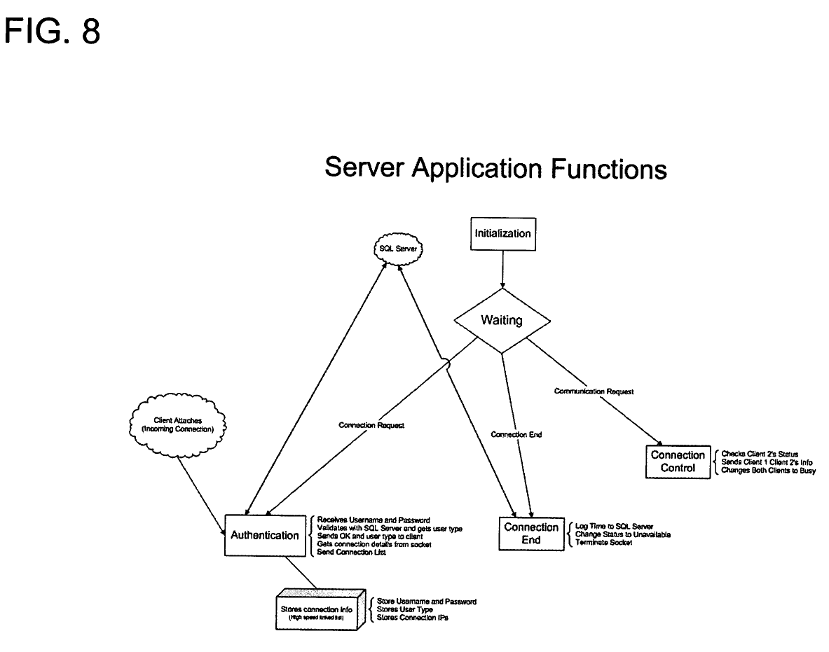

FIGS. 6-8 depict functional system diagrams demonstrating functionality that can be implemented in some illustrative embodiments. In this regard, FIG. 6 is a global design model diagram, FIG. 7 is a client function diagram, and FIG. 8 is a server function diagram. Among other things, these diagrams illustrate some functionality that may be employed for communications. In these figures, the management system of training entity is referred to at VLMS. In FIG. 6, the clients 1-4 represent various client computers, such as, e.g., student computers. In these illustrative examples, the communications can be facilitated utilizing a MICROSOFT's NET MEETING video conferencing software. As shown in these FIGS., the reference NM API refers to an application program interface to NET MEETING functionality. As shown in FIG. 7, the client computers can in these embodiments perform the illustrated functionality, including, initialization of an audio and/or video call, authentication, waiting, call command, call received, and call ended functionality. As shown in FIG. 8, the server can include additional functionality to, for example, manage the communications between multiple client computers, such as, e.g., connection control, authentication, and connection end functionality.

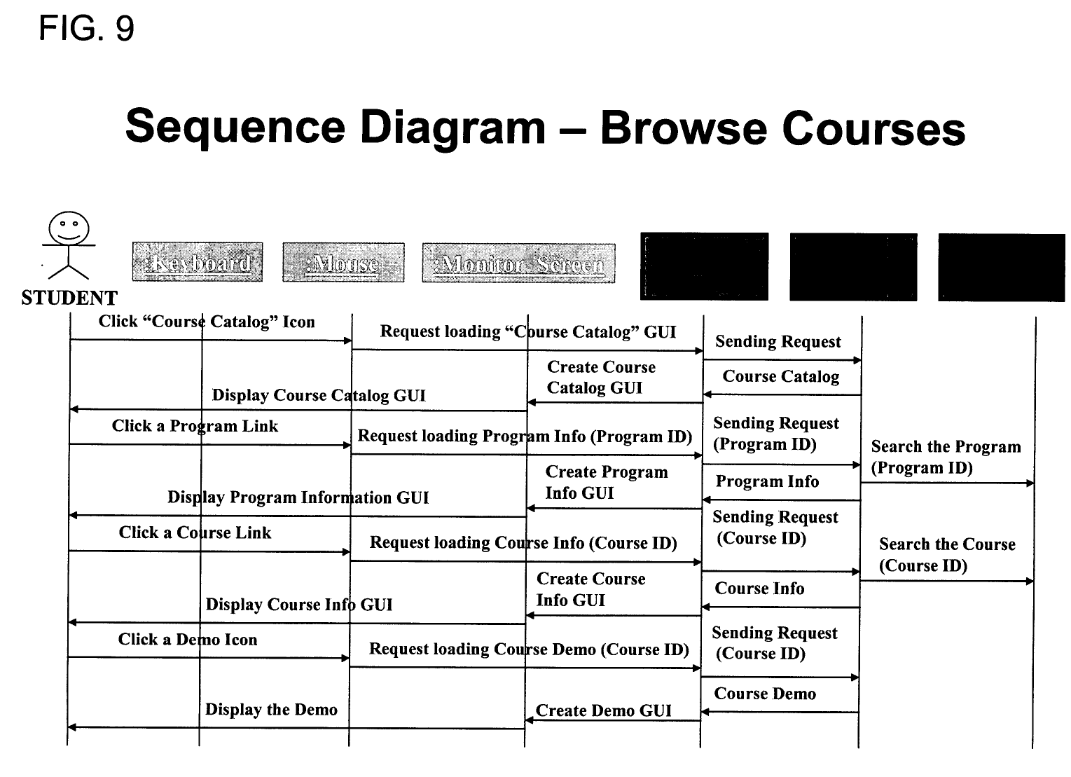

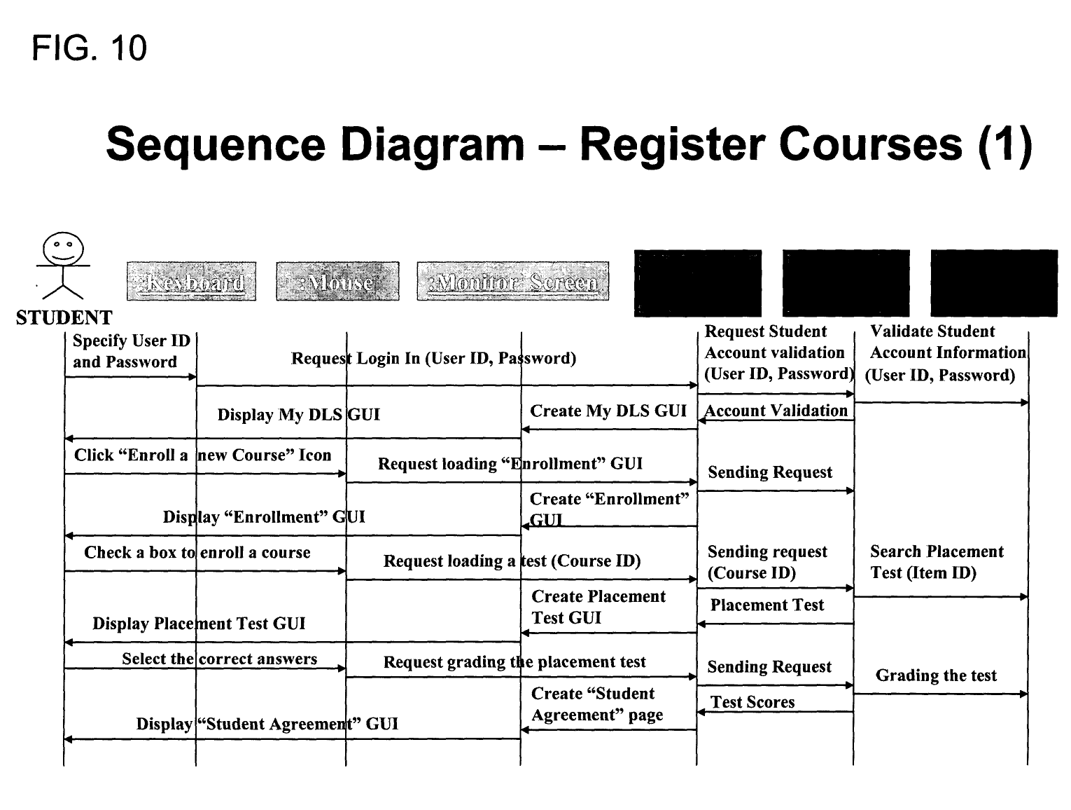

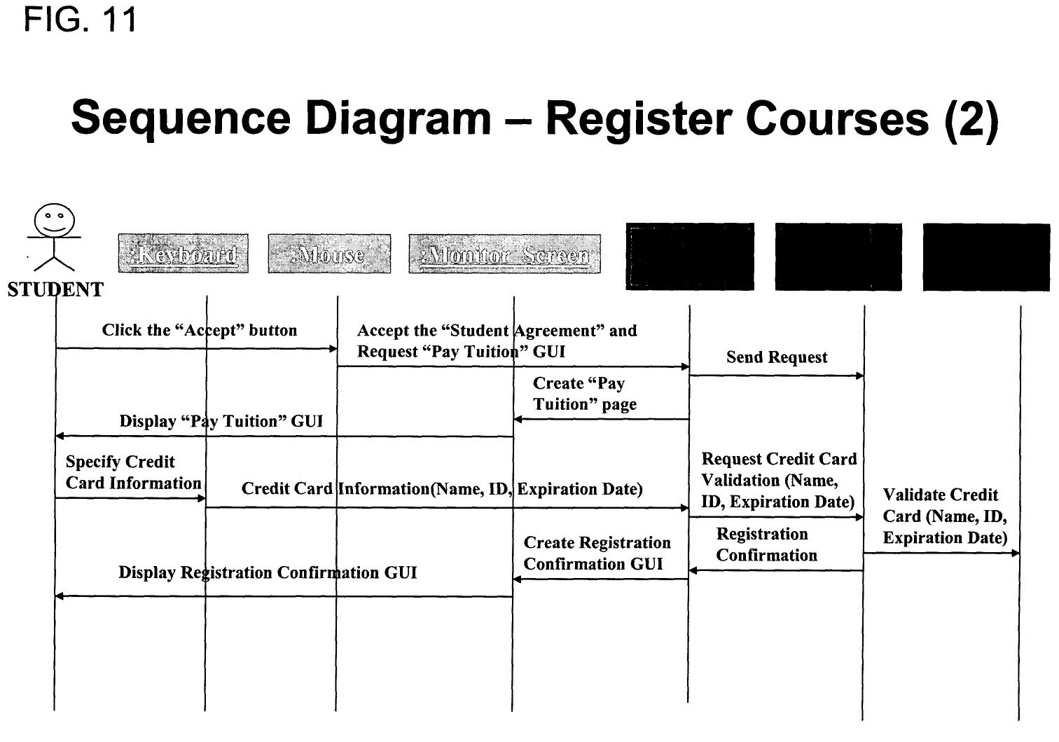

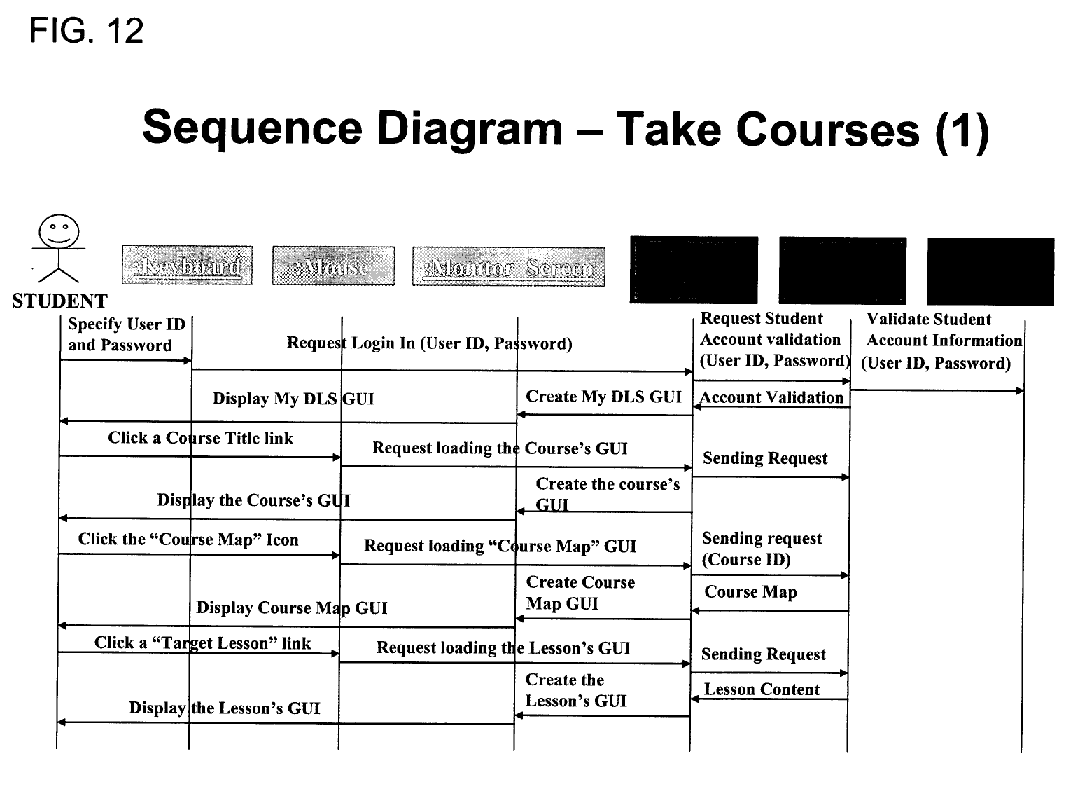

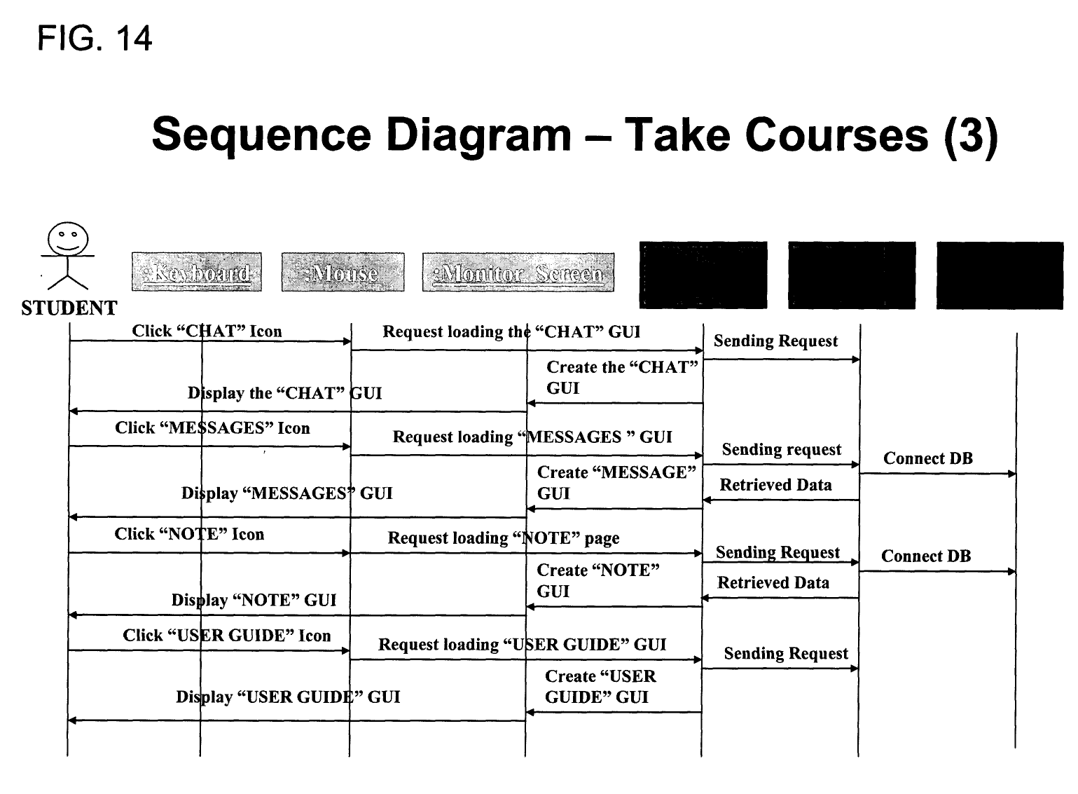

FIG. 9 is an illustrative sequence diagram showing illustrative communications between nodes and/or components and operations performed in some illustrative and non-limiting embodiments related to a student's use of the system to “browse courses” in some illustrative embodiments. Similarly, FIGS. 10-11 together form an illustrative sequence diagram showing illustrative communications between nodes and/or components and operations performed in some illustrative and non-limiting embodiments related to a student's use of the system to “register for courses” in some illustrative embodiments. Similarly, FIGS. 12-14 together form an illustrative sequence diagram showing illustrative communications between nodes and/or components and operations performed in some illustrative and non-limiting embodiments related to a student's use of the system to “take courses” in some illustrative embodiments. It should be understood based on this disclosure that in some embodiments, one or more operation can be eliminated and that various other operations could be employed in other embodiments.

### Description of Exemplary Embodiments

In some exemplary embodiments, a multi-phase training simulation system is provided that includes a modular system for learning by a student with the remote assistance of an instructor in multiple phases. In some embodiments, the system is preferably designed to facilitate the transition from an instructor-based environment to a remote controlled machine or virtual reality based environment. The system can be especially useful for teaching a multitude of higher level education and training disciplines that involve the development of advanced skill sets in a relatively short time, such as, e.g., foreign language training, management of special crisis situations, military and natural disasters first responders training, and/or coordination of multidiscipline teams at times of crisis.

In some embodiments, an instructor assisted, remote controlled, virtual reality environment can be created to provide an ultimate teaching/learning system. In exemplary embodiments, the system begins with the integration of a plurality of instructor assisted computerized training stations in a classroom setting to gradually increase the student's use of a computer and gradually reduce the student's dependency on the instructor. While establishing and maintaining a link between both the student and the instructor, the system is gradually transformed into a remote controlled educational environment that can be located at a student's location and/or at other training sites distant from the instructor site.

In some embodiments, a multi-step process is provided that allows the use of a computer network, such as, e.g., the Internet, to connect and control the machines. In exemplary embodiments, however, the Internet is preferably not used as the primary teaching tool in individual processes (such as, e.g., to deliver entire course contents during training).

Illustrative Systems and Processes (Exemplary Phases and Functionality)

In exemplary embodiments, a system is provided that comprises multiple computer stations which are remotely controlled by an instructor (see, e.g., illustrative control functions described herein-below) who is connected by a modem or the Internet. Preferably, each machine (e.g., computer station) can be used by a single student who needs to learn a new concept. In exemplary embodiments, the content of the topic is contained in the student's computer station which, in turn, is driven remotely by the instructor. In exemplary embodiments, in contrast to existing “Internet learning” where the content resides in a remote server connected to the student's computer via the Internet, the content preferably resides substantially in the user computer station(s).

In some exemplary embodiments, a multi-phase learning process can be provided. In some embodiments, one or more, preferably all, of the following phases could be implemented.

In a first phase, as shown in FIG. 21 (depicting an instructor I proximate to a student S seated at a desk), a substantially completely traditional instructor based learning system is used. In this early stage of learning, the student begins to use a training simulation module.

In a second phase, as shown in FIG. 22 (depicting an instructor I proximate a student S seated at a training simulation module (TSM) computer system), the process is instructor assisted and the topic learned is divided into a large number of smaller topics incorporated into learning modules. Preferably, the instructor dictates the flow of the smaller topics for the student. Preferably, the student can keep repeating these learning modules for these topics until learned.

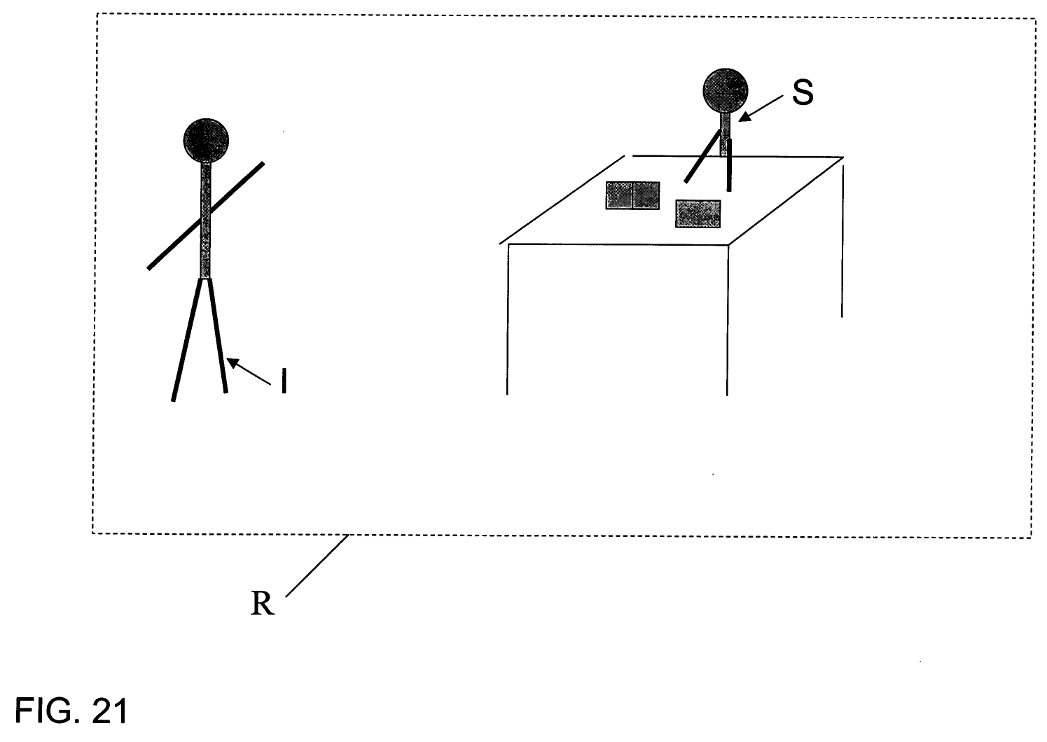

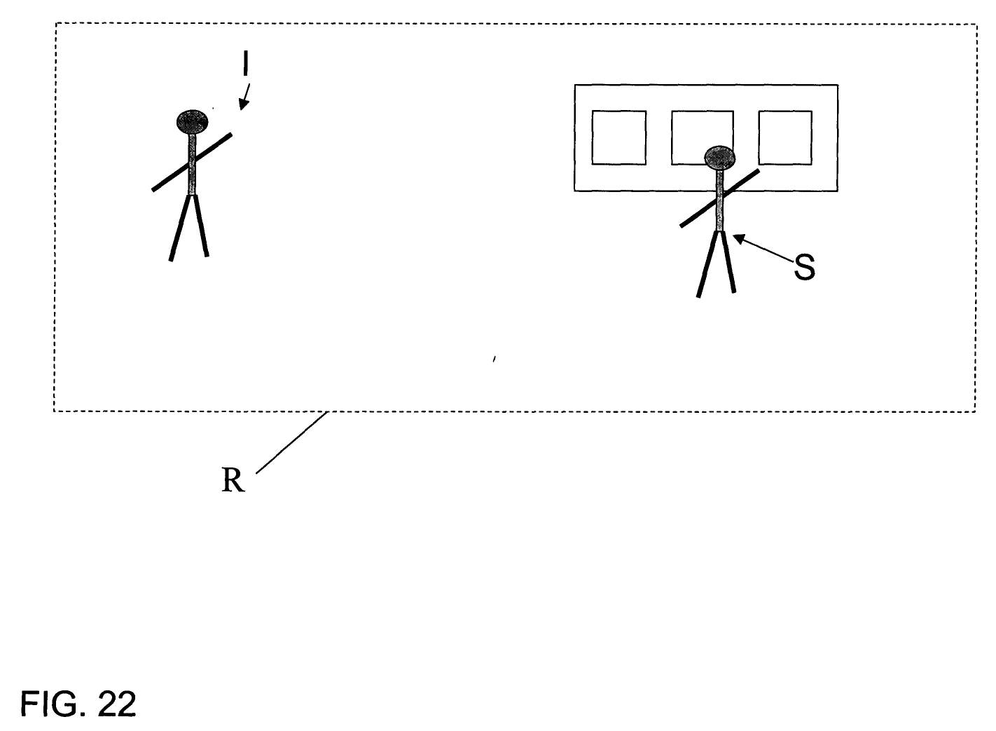

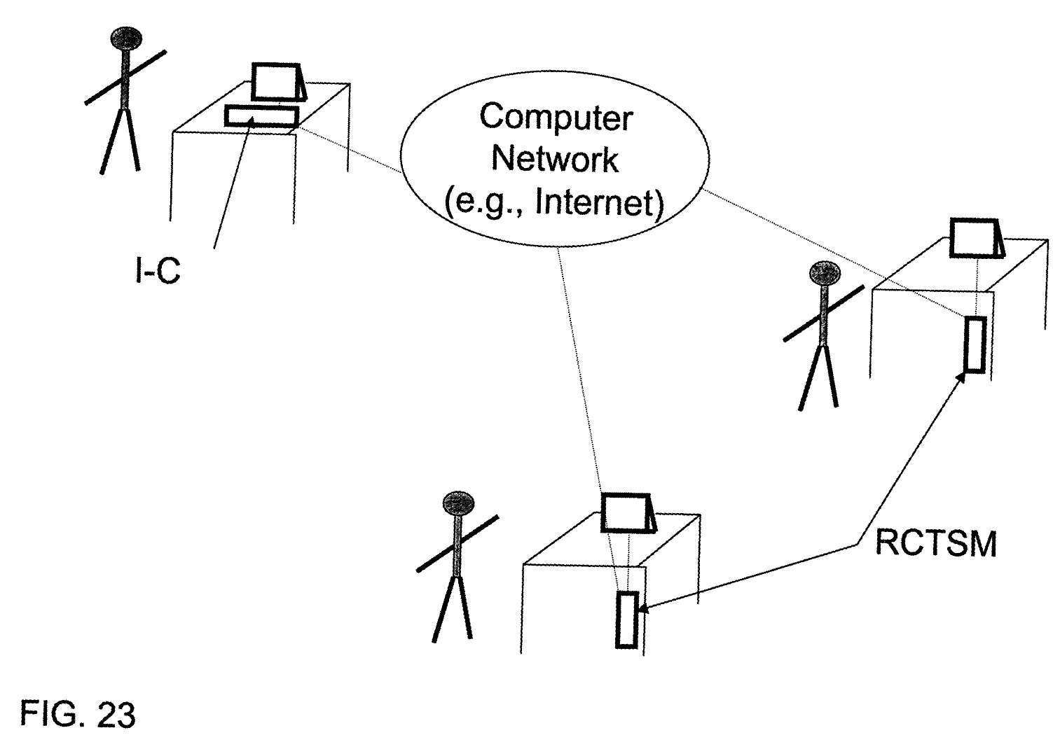

In a third phase, as shown in FIG. 23, the processes uses a remote controlled training simulation module (RCTSM) where the student is completely separated from the instructor. Preferably, the contents of the lectures are stored in a self-contained box (e.g., the RCTSM) that the instructor can access remotely (such as, e.g., via computer network, such as, e.g., the Internet) to download lessons and/or to get student results. In this mode, the system functions to enable more intelligent control of the flow of lectures based on the needs of the student. Among other things, this phase can be advantageously utilized for high school and college level courses.

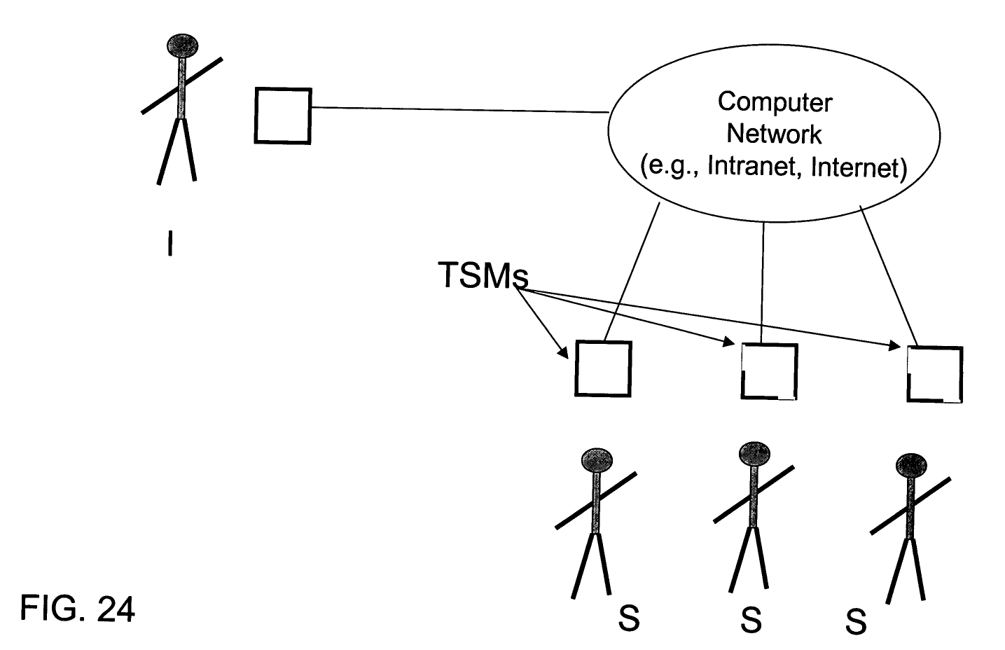

In a fourth phase, as shown in FIG. 24, a novel virtual reality training simulation module (TSM) is preferably utilized. In this form of learning, the student preferably learns concepts through gaming technology where the instructor can put the student in a substantially real world situation in order to practice concepts that the student has learned previously. This mode is particularly advantageous and appropriate for army training, intelligence training and/or other forms of training pertaining to national security or the like.

In various embodiments, any form of concepts can be learned or studied in accordance with one or more embodiment of the invention. A few illustrative concepts that can be learned or studied with one or more embodiment of the invention include, e.g., language, culture, high-school courses, college courses, seminar courses, continued education courses, technology based training and/or other appropriate concepts.

In the exemplary embodiments, the system includes a variety of support components, such as, e.g., a content generation tool (CGT) to facilitate generation of content, an up/down link between user computers and a central stations, and a customer information system.

Phase 1 (E.G., Instructor Based Learning)

In some exemplary embodiments, in a phase 1 (e.g., an early stage of learning of a particular course or subject matter), the student learns from an experienced instructor instead of using computer based training or with minimal computer usage. That is, the student preferably does not have to be immediately taught via computer based training on the first day of training. The degree of use of a computer by the student at this stage of the process is preferably low or none. For example, as depicted in FIG. 21, the instructor and the student(s) are preferably located within the same physical region R (such as, e.g., within the same room within a building or the like).

In some instances, this can be an important step for difficult concepts such as, by way of example, language training. The length of this phase can depend, e.g., upon the speed and technical aptitude of the student(s). In some illustrative embodiments, this phase can be about two weeks or longer.

In some embodiments, during this phase, the instructor is responsible for preparing all the training material. In some embodiments, this material can include, e.g., mostly paper based materials, as well as tapes (e.g., audio tapes, etc.), CDs, Video Tapes, etc.

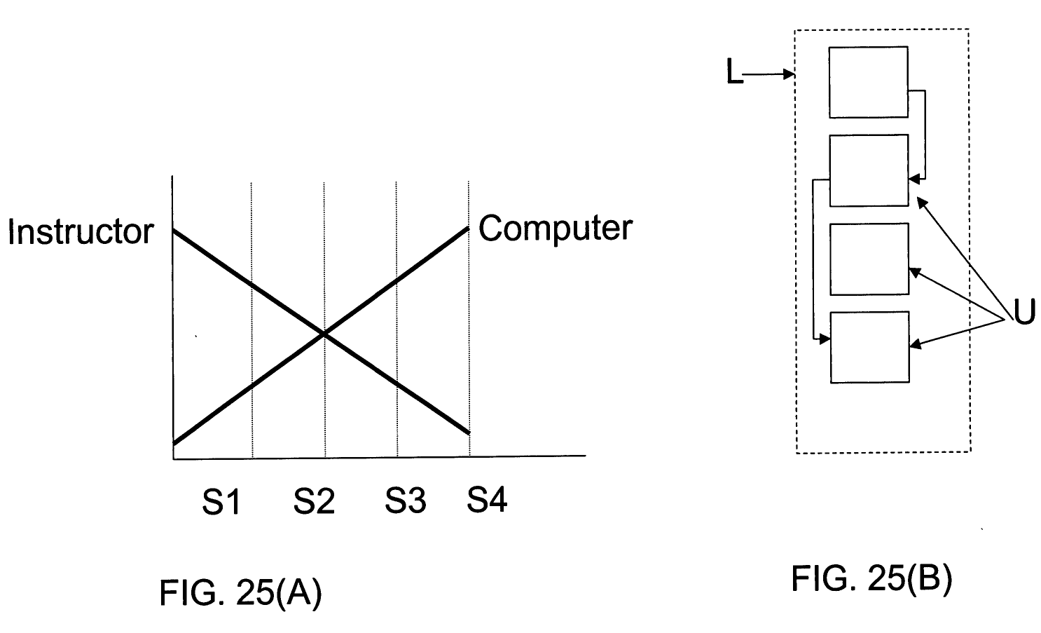

In some exemplary embodiments, towards the end of phase 1, the student begins to be introduced to the use of a computer (such as, e.g., a training simulation module). FIG. 25(A) demonstrates how a student can gradually be introduced to a computer (see, e.g., curve C), such as, e.g., increasing computer usage time, and concurrently gradually removed from the instructor (see, e.g., curve 1), such as, e.g., decreasing time of instructor participation.

Phase 2 (E.G., Training Simulation Module)

In typical in-class learning situations, an instructor only has a certain number of hours to spend with the student every week. Typically, the instructor may spend a few hours in direct contact with the student (e.g., for in person communications). The student is then left to work on his/her own, using, for example, notes, tapes, and text.

According to some exemplary embodiments, a system is provided which is referred to herein as a training simulation module (TSM). In exemplary embodiments, the TSM is adapted to operate as a tutor that helps the student learn faster by using, e.g., interactive features. Preferably, the TSM will, to some degree, reiterate concepts and lessons presented by the instructor.

In some exemplary embodiments, an individual student's TSM has three monitors that together provide (1) audio/video playback [e.g., at a first of the monitors], (2) text [e.g., at a second of the monitors], and (3) Internet capabilities for the student [e.g., at a third of the monitors].

In some exemplary embodiments, an individual student's TSM will include at least one computer that is networked to a computer operated by the instructor and to one or more central server computer. In some embodiments, the student's computers can include, e.g., any appropriate computers, such as, e.g., including, e.g.: a central processing unit; memory (e.g., RAM, etc.); digital data storage (e.g., hard drives, etc.); input/output ports (e.g., parallel and/or serial ports, etc.); data entry devices (e.g., key boards, etc.); etc. In some embodiments, these computers can operate as client computers and may contain, in some embodiments, browser software for interacting with the server(s), such as, for example, using hypertext transfer protocol (HTTP) to make requests of the server(s) via the Internet or the like.

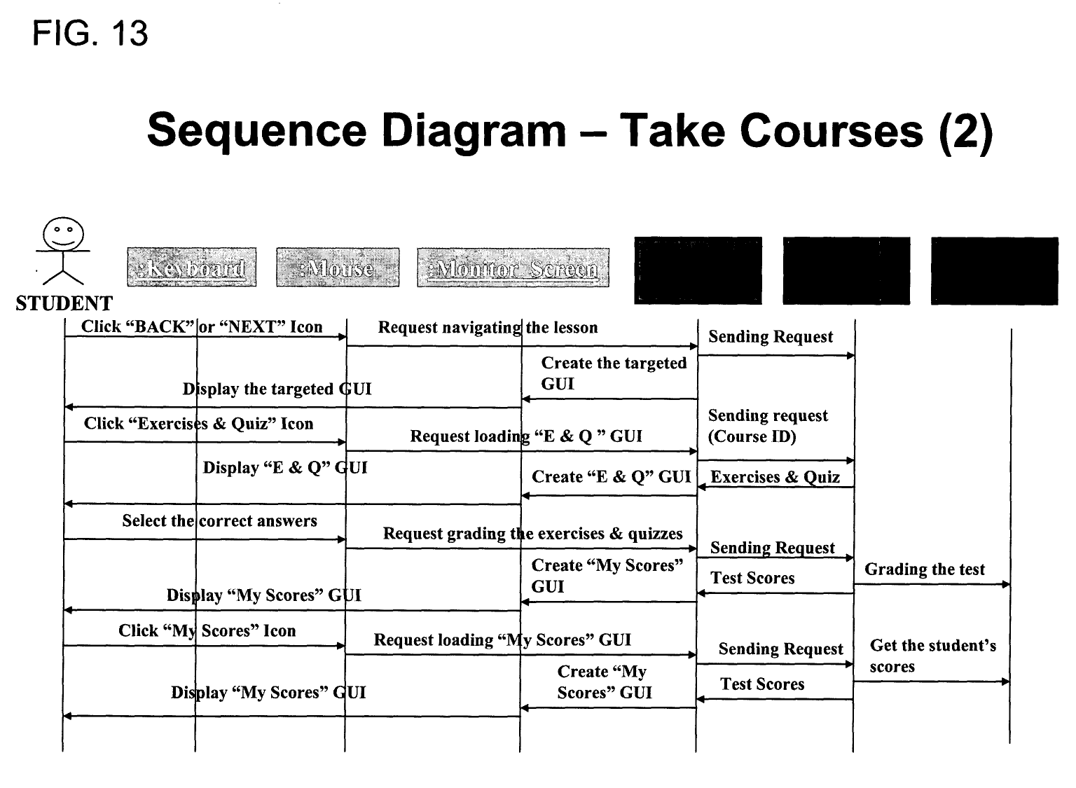

In some embodiments, the TSM can include a computerized station or console. The computerized station or console may support an independent computer, may have computer components built therein and/or may be connected to a computer that is displaced from the computer station or console. In some illustrative embodiments, as shown in FIG. 13 the TSM can include a console (e.g., that supports system equipment in front of a seated user) having a generally convex curvature so as to partially surround a seated user (e.g., student). Preferably, as shown, the console includes a plurality of display screens or monitors (or alternatively, a large monitor having a width of at least about 2.5 to 3 feet or more and/or having a generally curved structure to surround a user could be used). In some preferred embodiments, a left monitor is used to display reference materials, a central monitor is used to display audio/video conferencing (such as, e.g., using a camera & microphone mounted on the console), a right monitor is used to display materials being shared online and/or communicated (such as, e.g., providing audio, video, chat, white board, ftp and/or other functionality). In some illustrative embodiments, a single console can have a height of about 44 inches, a length of about 85 inches, and a width of about 36 inches.

In some illustrative embodiments, each TSM can include the following system components: support console (discussed above); INTEL Pentium IV 2.53 Mhz; 512 Megabytes System Memory; 80 Gigabyte HD; 16×DVD-ROM Drive; three 17 inch liquid crystal displays; 56K Internal Modem; 10/100 NIC; 6 front panel USB ports; MS Windows XP Pro; Optical USB Mouse; Multimedia USB Keyboard; USB Communications Headset; System Power Strip. In some illustrative embodiments, each TSM can include the following Internet connections: cable modem; DSL (512 KPS); Partial T1 (512 KPS); T1 line. In some embodiments, the TSM can include some or all of the following other features: a touch screen; voice command software; a printer; a scanner; a touch pad; a telephone set hook-up; CD-RW/CD-ROM/DVD; a light pen; a recording device and/or other features.

FIG. 16 shows a plurality of console arrangements and/or structures according to some illustrative embodiments. As shown at the left side of the figure, a plurality of like consoles can be grouped together to create an efficient cluster configured substantially as shown (with FIG. 16 being substantially to scale—proportionally—in some embodiments). Additionally, the middle region of FIG. 16 shows illustrative top and front views of a single console and includes reference characters that also correspond to illustrative dimensions, in inches, in some non-limiting embodiments of the invention. The items at the right side of FIG. 16 depict illustrative top and front views of two optional stands that may used in some embodiments (such as, e.g., shown added to the cluster at the left side of FIG. 16).

In some embodiments, the instructor computers can include computer stations or consoles similar to the student TSMs. In some embodiments, the instructors and students can use the same and/or similar computers and consoles, such as, e.g., TSMs which can have instructor and/or student functionality available upon proper user login, such as, e.g., entering appropriate user ID and passwords.

In some embodiments, the instructor can work with a plurality of students which can be situated together in arranged in a variety of ways, such as, e.g., in some preferred embodiments in a “cluster” of student stations, such as, e.g., in clusters of three or more students (such as, e.g., the five cluster grouping shown in FIG. 16). In some embodiments, the instructor can control the students' learning environments. Preferably, the instructor can interact with each student (e.g., via each student's computer) in a different way and, if appropriate, can enable two students to interact with each other (e.g., via there respective computers). While cluster arrangements, such as, e.g., shown in FIG. 16 can have various advantages (e.g., providing space savings, etc.), in some other embodiments, clustering is not required. In some illustrative cluster arrangements, adjacent consoles can, conveniently, be located directly or almost directly adjacent one another. In some illustrative embodiments, a single class room may include between about 3 to 10 clusters of about 3 to 6 consoles.

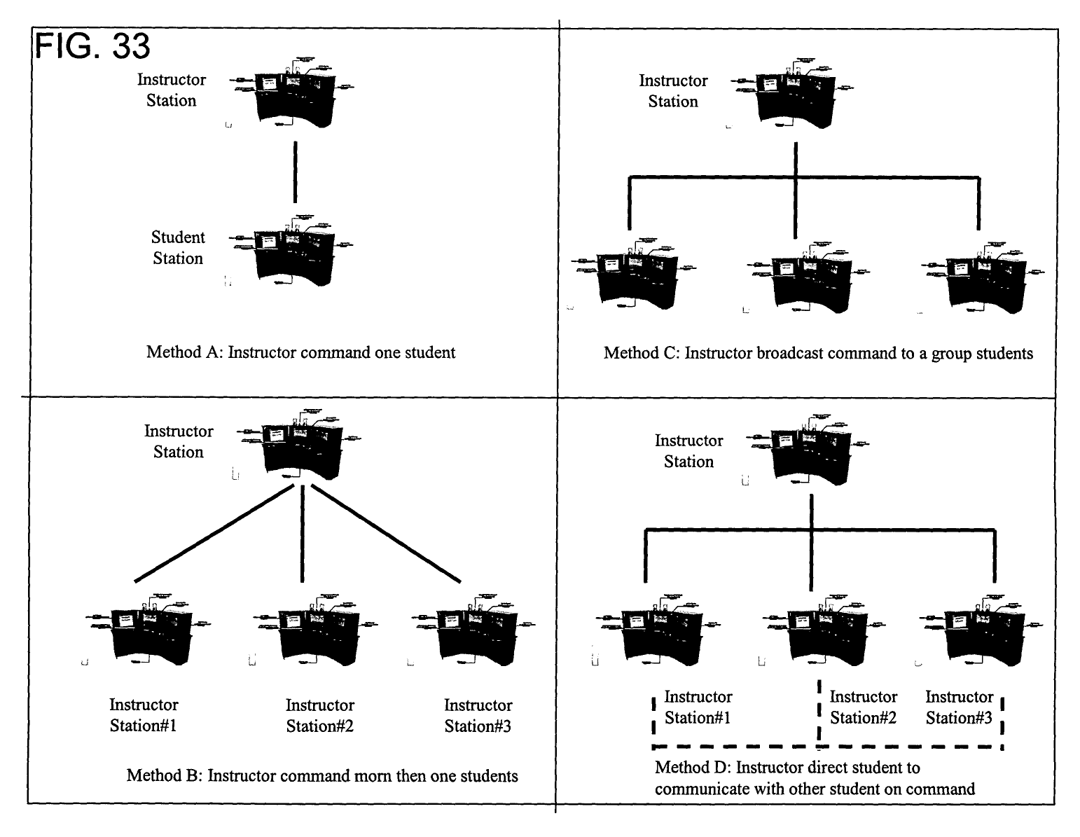

FIG. 33 is a schematic diagram showing a plurality of instruction methodologies that could be employed in some illustrative embodiments. In method A, the instructor can send instructor command signals to one student. This can be used, e.g., to create a one-on-one form of studying environment or the like. In method B, the instructor can send command signals to a subset of students (e.g., one or more of the students) within a class. This can be used, e.g., to facilitate collaboration on projects (to instruct a particular study group, to instruct groups of students operating at a similar level [such as, e.g., currently on a certain lesson unit or the like, to enable collaboration between certain students, etc.). In method B, the instructor preferably sends signals to one or more of the students in a class. In method C, the instructor can send command signals to an entire group of students. This can be used, e.g., to create a classroom form of studying environment (such as, e.g., to enable all students to hear test information and/or important class information, etc.). In method C, the instructor preferably sends a broadcast signal that can be received by all students (or substantially all students).

In some exemplary embodiments, the system can employ each of the methods A, B, and C. In addition, in exemplary embodiments, the system can employ each of these methods within the same training, learning or teaching environment (such as, e.g., during the same class, time interval or event). In this manner, students can receive a highly personal one-on-one type of experience as well as a full classroom experience and a collaborative type of experience.

Among other things, the multi-student combined teaching functionality can have substantial cost savings, rendering remote teaching more cost effective and profitable. By way of example, a single instructor can, e.g., provide a substantially one-on-one teaching environment to a plurality of students at a single time. In this manner, profits per instructor can vastly increase over systems that have essentially a one instructor per student environment. Additionally, clustering of consoles (which can be facilitated in part by the convex or arc-like nature of the consoles) can provide great space savings and, hence, further increase profitability).

In some embodiments, the use of student TSMs can enable the instructor to successfully manage and control the learning process for multiple students. In exemplary embodiments, the instructor is able to communicate directly with individual students via audio and/or video from an instructor's computer to provide feedback and instruction and to answer questions. In some embodiments, the audio and/or video communication is provided via a high bandwidth connection (such as, e.g., a dedicated line and/or via communication between the instructor and student computers taking place over a private network). Preferably, in this phase, while the student uses a computer for communication, from the student's perspective, it is very close to a “one-on-one” learning experience.

As illustrated in FIG. 25(B), in some embodiments, content for a lecture or lesson L is preferably embodied in or separated into smaller units U, which are stored in the TSM for use by the student(s). Preferably, the instructor can choose to assign a certain number of units U and/or a certain sequence of such lesson units to be completed by the student in order to learn specific concepts. For example, the instructor is preferably provided with a control interface at the instructor's computer that is configured to adapt the student's computer to perform a certain lesson plan (e.g., presenting a lesson in an instructor desired order) and/or that is configured to transmit instructions to the student(s) regarding the lesson order or the like. In this manner, the flow and interaction between the TSM and the student is preferably driven by the student and/or the instructor.

While in some embodiments, the instructor can control student machines, such as, e.g., to affect course content therein, a variety of forms of instructor control can be employed in various embodiments. Some exemplary types of modifications and/or changes to student computers that can be implemented based on instructor commands (e.g., sent from instructor computers) can include one or more of the following:

A. That instructor commands modify a sequence or flow of course content (e.g., lesson units) on at least one student computer. For instance, an instructor command can, in some embodiments, include a signal sent to a student computer (or to another computer such as, e.g., an application server) that includes a code that will enable and/or cause certain content to be presented to the particular student and/or students. In some illustrative examples, a student's computer can be disabled from performing certain operations (such as, e.g., moving forward to a lesson unit) until the instructor enables and/or causes the student's computer to do so. Thus, for instance, a student can await instructor approval before moving forward and/or an instructor can dictate the materials to be reviewed by a student.

B. That instructor commands enable and/or cause student computers to access files (e.g., information files) stored on said student computers (e.g., wherein such storage is preferably prior to a communication interval or event, such as, e.g., a class session in which said instructor computers and student computers are in communication).

C. That instructor commands enable and/or cause other computers, such as, e.g., application servers to send data, information, text, documents, audio, video and/or the like to student computers.

D. That instructor commands enable and/or cause student computers to run programs (e.g., programs resident on and stored on said student computers [e.g., wherein such storage is preferably prior to a communication interval or event, such as, e.g., a class session in which said instructor computers and student computers are in communication], run API programs and/or other programs).

E. That instructor computers enable and/or cause student computers to initiate and/or receive communications with other computers (such as, e.g., other student computers). For example, the instructor computer can, e.g., initiate communications (such as, e.g., real time audio and/or video communications between a plurality of students). In this manner, for example, the instructor can bring students together in various training exercises, study groups and/or the like, even if such students are remote from one another, such as, e.g., even being located remotely in different regions, countries or the like.

F. That instructor computers enable and/or cause student computers to display particular information.

G. That instructor computers enable and/or cause student computers to print information.

H. That instructor computers enable and/or cause student computers to access and/or receive certain information on a remote server or database (such as, e.g., over the Internet). For instance, the instructor computers can cause the student computers to send requests for content and/or to access to particular secure pages (e.g., providing access codes or the like) and/or can cause remote servers to send content and/or information from particular secure pages (e.g., secure Web Pages).

I. That instructor computers can enable and/or cause student computers to receive one or more control function (such as, e.g., A-F above) or to be granted increased user permissioning from a remote server, of the instructor computer for limited time, purposes or the like). For example, this may be used to enable a student to make a class presentation, to work with other students in a class on a project, or the like.

In some embodiments, one or more student or other computer can also be enabled to effect some modifications and/or changes various other student computers based on commands from that student or other computer (e.g., sent from that student or other computer), such as, e.g., enabling and/or causing other student computers to initiate communications, to access files, to run programs and/or the like, and enabling and/or causing effects as set forth in part “I” Immediately above.

In an illustrative and non-limiting example, in language training, video playback can be used to help teach difficult concepts such as, e.g., pronunciation. In an illustrative example, there can be a large selection of videos with, e.g., close-up videos of the instructor talking so that the student can watch a particular selection as long as desired or needed in order to learn the desired concept.

Content Generation Tool (CGT)

In some exemplary embodiments, in order to facilitate development of courses and usability of the system a content generation tool (CGT) is provided. In some exemplary embodiments, the content generation tool can be programmed into a central computer, such as, e.g., an application server, other server or the like. Preferably, an instructor can access the CGT remotely from the instructor's computer or from another remote computer, such as, e.g., by communicating over the Internet or another network or the like.

In some examples, an instructor may be an expert in the field, but may likely not be very computer savvy. For the system to work most effectively, it is thus desirable to enable the instructor to be able to transfer course contents from the instructor's environment to the system environment (e.g., an HTML-based and/or the like environment). Preferably, the tool helps the instructor to create lesson units U and the learning environment for the TSMs with a minimal amount of technical knowledge.

In some embodiments, the CGT can include a database based program that the instructor uses to create the content using templates. Preferably, the CGT is designed to guide the instructor and/or a technical assistant through the process of taking the course material from, e.g., a paper based environment and using it to build teaching files that are stored in the system (e.g., in a central managing server).

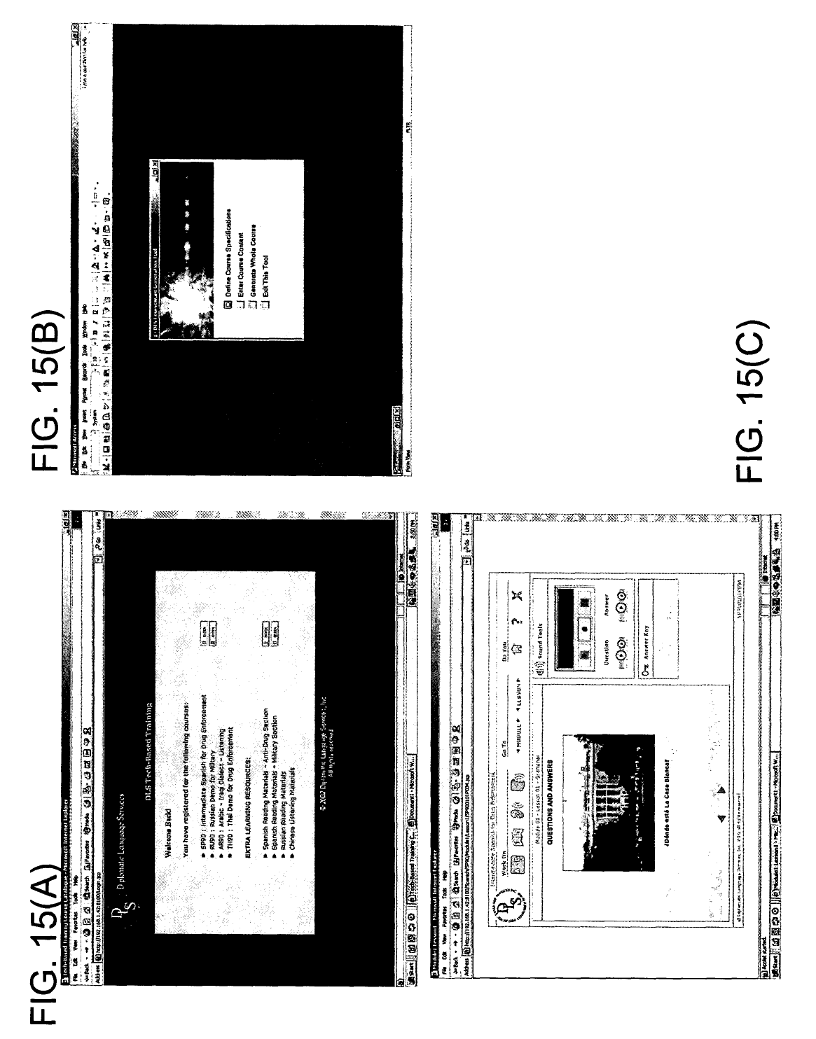

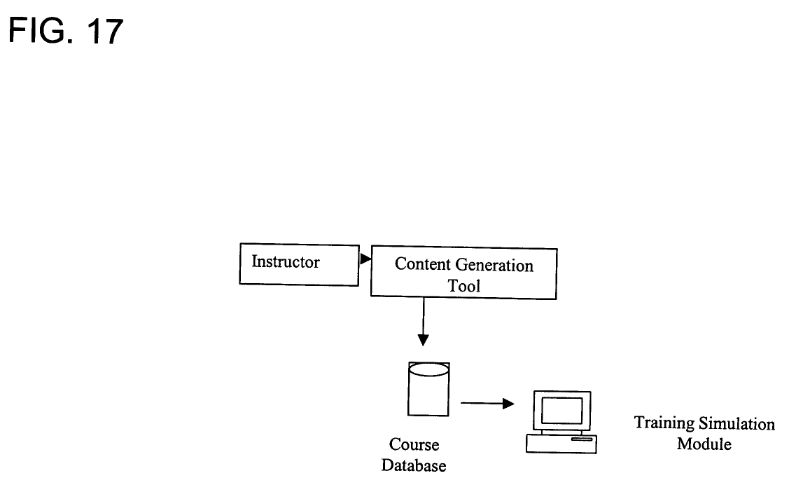

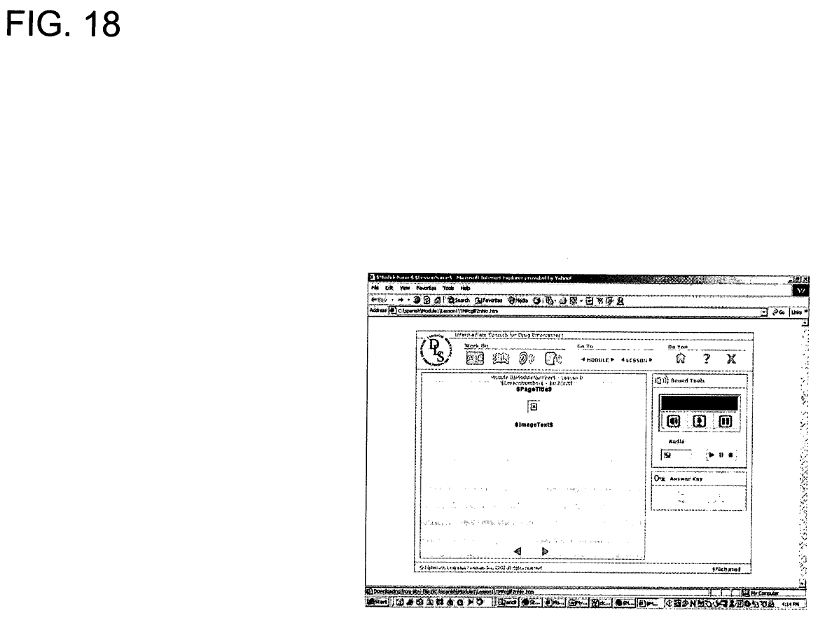

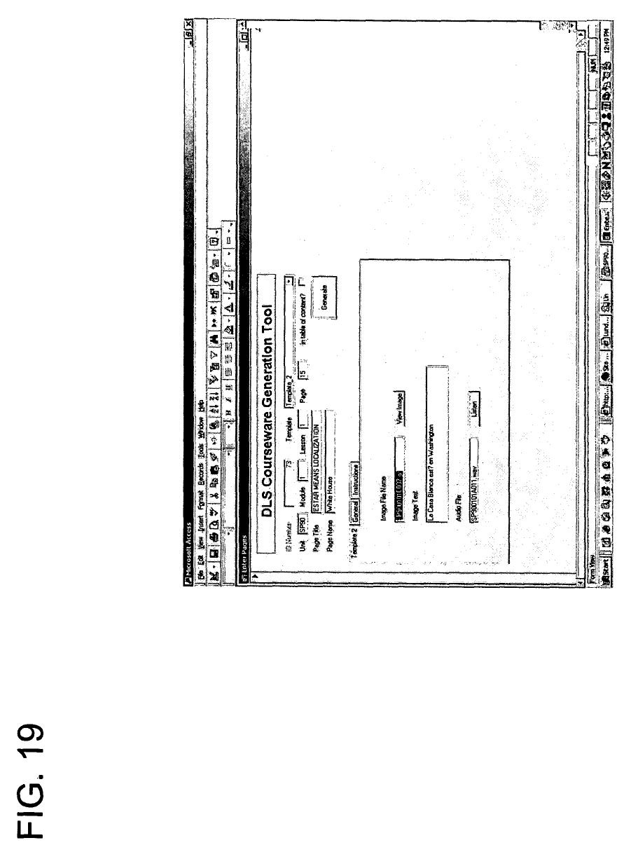

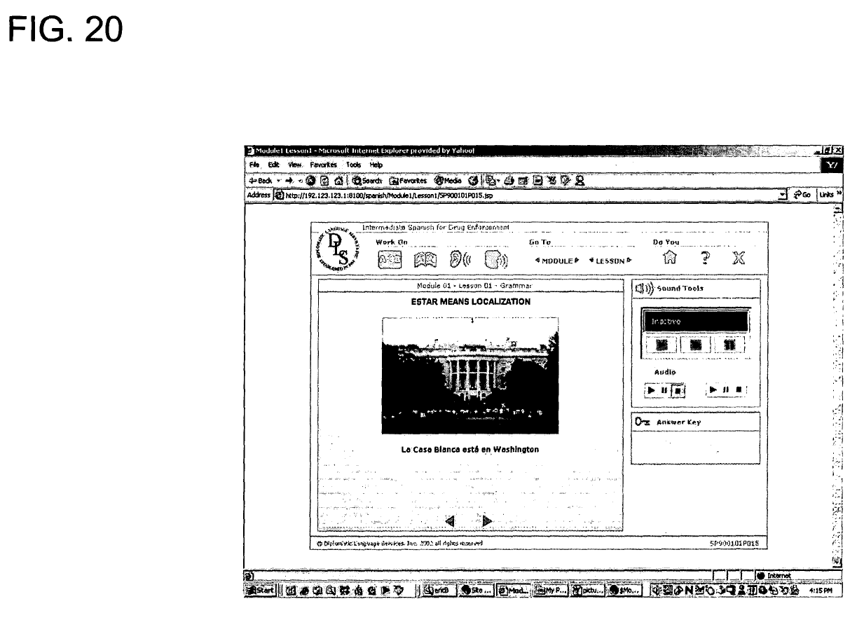

In some illustrative embodiments, to generate a lesson unit (such as, e.g., a vocabulary or other lesson unit), an instructor can select a picture and/or text and record a corresponding word or words in audio. Preferably, the CGT generates an appropriate screen for use by the student in learning the lesson unit. FIGS. 15 and 16 show illustrative screen shots that can be presented to an instructor or the like using the CGT tool, and FIG. 17 shows an illustrative screen shot that can be generated by the CGT for use by the student(s).

In exemplary embodiments, an instructor can choose substantially all characteristics of the lesson unit. For example, the instructor can choose which items (such as, e.g., vocabulary words or other items) will be taught to the student(s). Certain item sets (such as, e.g., vocabulary sets) may be appropriate for some students but not for others.

In some illustrative embodiments, the content generation process can include one or more, preferably all, of the following steps:

1. A user accesses a plurality of templates (e.g., HTML template pages or the like). These pages can be programmed in HTML or can be readily created using standard editing software (such as, e.g., DREAMWEAVER or any other HTML editing software).

2. In place of the text, and filenames, one can use $variable$, such as $header$, $title$.

3. The database fields can be created to match the $variable$ so each variable in the template matches a database field.

4. A user then clicks or pushes a generate button or icon, the template file is read, and each $variable$ is replaced with an equivalent database field.

5. The resulted file is saved with a unique name for the generated page

Preferably, to create a new course, a new database file is created. Then, the instructor preferably enters the course into the database. In some embodiments, the database can be given to a developer (which can include a human operator or which can be entirely automated) that creates the generated files one after the other until the whole course is done. In this manner, the technical work is removed from the instructor. For reference, FIG. 17 shows an illustrative architectural diagram demonstrating the functional relationship of the content generation tool.

Phase 3 (Remote Controlled Training Simulation Module)

After the student is able to complete stages one and two, he is ready to continue learning with less interaction from the instructor. At the end of the second stage, the student is preferably sent home with a remote controlled training simulation module (RCTSM). In some exemplary embodiments, the RCTSM can be generally similar to an e-book, a laptop computer, personal digital assistant or other small portable computer device.

In exemplary embodiments, the RCTSM includes contents of the lectures stored therein (e.g., as a self-contained box) that the instructor can access remotely to download lessons and/or to monitor student results. In the exemplary embodiments, the RCTSM machines are programmed to more intelligently control the flow of lecture materials (e.g., lesson units) based on the needs of the student. The RCTSM devices and processes related thereto are particularly appropriate for high school and college level courses.

From the student user's point of view, the RCTSM is a complete box that is easy to connect and use. In exemplary embodiments, all of the lessons are arranged using Internet related technology, such as, e.g., HTML technology and the like, so the user learns by looking around (e.g., clicking on links to move between pages or the like). That is, the courses are preferably presented using HTML, Java and the like which provides hot spots (e.g., links) on the display screen to be clicked or pressed to navigate around the course. In exemplary embodiments, the courses include sound, video, and pictures to help students absorb the information.

From the instructor's point of view, the interaction with the student is at a higher level and more remote than in phases 1 and 2. As shown in FIG. 23, in phase 3, the RCTSMs for one or more students are preferably connected over network, such as, e.g., the Internet, to an instructor's computer I-C. In this manner, the instructor can readily receive the students' answers to questions posed at their RCTSMs. In addition, in this manner, the instructor can also receive other information regarding the students' activities on their RCTSMs. For example, in some embodiments, the instructors can receive information regarding how long the student spent on a particular screen or lesson unit, how many screens or lesson units the student completed, and the like. With this information, the instructor can evaluate the students' progress and determine where additional work may be necessary. In exemplary embodiments, the instructor can then send commands to individual and/or multiple RCTSMs (such as, e.g., to provide instructions to the students and/or to provide feedback to the students).

In exemplary embodiments, the RCTSMs can store a large number of lesson units (such as, e.g., having such units already preprogrammed) before the box is released to the student. In some illustrative embodiments, not all of the lesson units contained on the box will be applicable or even made available to a particular student. However, this pre-programming can advantageously avoid the time consuming process of having to download necessary content over public networks, such as, e.g., the Internet or from computer disks or the like.

In exemplary embodiments, having RCTSMs networked with a central server and/or an instructor computer (such as, e.g., via the Internet or other network) enables remote authentication of individual user identification (e.g., student identification) and enables flow commands to be sent (such as, e.g., from the instructor's computer and/or from a central server) to the RCTSMs. In some exemplary embodiments, these flow commands can instruct the RCTSM devices as to which of the learning units U or modules (which can be already programmed into the device) are to enabled for use by the student.

In some embodiments, the learning units U programmed into the RCTSMs can be built by taking the experiences of one or a plurality teachers and combining them into a single tool. The tool can then be used, as described herein, to adjust and/or adapt to the student's needs. In addition, the tool can change with time, such as, e.g., as the needs of the student(s) change(s) and/or can accept input from the instructor to change the behavior of the system. Thus, the RCTSM can preferably adapt to the personal needs of the student(s).

According to some embodiments, one or more, preferably all, of the following steps can be employed.

1. Preferably, each topic is designed using many screens (preferably, the screens include redundant aspects).

2. Preferably, the RCTSM presents the student with the course materials and provides a means for contacting the instructor. For example, the means for contacting the instructor can include an audio communication and/or a video communication. Any appropriate communication means can be used, such as, e.g., common telephone communications, wireless communications, digital and/or analogue communications, etc.

3. Preferably, in operation of the RCTSM, a student can read through text, listen to audio and watch a video (e.g., a pre-recorded video).

4. Preferably, as the student user uses the system, feedback is collected from the user's RCTSM device. In some embodiments, the feedback gathered includes at least one, preferably all, of the following categories:

Time spent on each screen by the student;

Answers to questions, quizzes and/or the like; and/or

Questions and/or responses submitted to instructor.

In exemplary embodiments, each screen of information has a set of basic topics associated with it. In this manner, the system can enable the use of the feedback to determine which of the topics the student needs additional work on before going further.

Course Database (CDB)

In the exemplary embodiments, a course database is created that includes a repository of courseware. In some exemplary embodiments, course data from the course database will be preloaded on devices referred to herein as a remote controlled training simulation module (RCTSM) or an adaptive learning box (ALB). An ALB can include a device (e.g., a portable device) that will be given to a student for use at a remote location. Preferably, all or substantially all of the courses to be taken by the student can be preloaded on the box to ensure that the material at the highest quality is delivered to the user regardless of a network speed (e.g., content delivery would, thus, not be dependent on reception of the content over a network). In some embodiments, the box could also include material related to other classes that the student has not or may not register for. Preferably, when a user tries to use the system, he will be required to authenticate himself (such as, e.g., by entering a user name, password and/or the like). In exemplary embodiments, the information will be checked against a customer information system (CIS) database and only those courses the user is authorized for will be unlocked (i.e., accessible by the student). In some embodiments, the CIS database can be located on a central location remote from the ALB, such as, e.g., proximate a central server. In such embodiments, the CIS information can, e.g., be accessed from the ALB, such as, e.g., via the Internet or the like (such as, e.g., either in real time and/or at certain times and stored in the ALB for a period of time).

Customer Information System (CIS)

In some exemplary embodiments, customers can subscribe to classes either via their ALBs, via an Internet Web Site and/or via another means. In this regard, the CIS tool used preferably includes means for rendering payments (e.g., on-line payments) and means for providing authorizations.

The Remote Controlled Training Simulation Module (RCTSM)

In exemplary embodiments, a RCTSM can function as a user interface to the learning system. In exemplary embodiments, it can be used as:

1. A standalone tool (e.g., without a need to connect to a remote computer or system);

2. An instructor-aided teaching tool (e.g., wherein an instructor can interact remotely with the tool and/or with the student via the tool); and/or

3. A remote instructor (e.g., providing remote access to an instructor, such as, e.g., via real-time audio and/or visual communications, e-mail and/or other communications and/or providing instructor functionality remote from a classroom environment).

In some exemplary embodiments, the RCTSM can include at least some, preferably all, of the following components:

1. A processor (preferably having a high speed and capacity);

2. Digital memory (preferably a large memory for quick responses, etc.);

3. Digital data storage (such as, e.g., a hard drive for storing, among other things, class information);

4. A touch screen monitor;

5. A pointer (such as, e.g., a USB mouse) and keyboard;

6. A communications port (such as, e.g., providing a connection to a computer network, such as, e.g., the Internet to enable communications and/or customize courses).

The Uplink/Downlink

As set forth above, existing delivery mechanisms (such as, e.g., using computer disks [CDs] or Internet communications [such as, e.g., TCP/IP and the like communications]) are ineffective because: CD media is typically limited in size, can take a long time to download, can be more difficult for users to operate and has other deficiencies (such as, e.g., being more easily copied and/or pirated); real-time learning on the Internet or World Wide Web is limited by the bandwidth of the Internet.

On the other hand, in some exemplary embodiments, the system can include lessons preloaded on a student user's machine. In the exemplary embodiments, if there are updates to be sent to the student's machine, the updates can be delivered outside of a class period or a studying period (such as, e.g., in advance of studying and/or overnight and/or at a time when the network is at a lower usage rate). In some embodiments, a teacher may update a user's machine during a class or studying period (such as, e.g., to update materials and/or to provide additional materials). However, in exemplary embodiments, the student user will not have to settle for lower quality audio or video because of computer disk size limitations or Internet traffic load (for example, pre-recorded audio and/or video lessons can be stored on the student's machine and the machine and be designed to highly efficiently play such pre-recordings).

In exemplary embodiments, the uplink/downlink functionality includes two program components. A first program component is located in the student user's machine or box. A second program component is located on the central system server. In exemplary embodiments, the two programs components use compression and/or encryption to ensure the security and/or speed of the transmissions) which connects all the components. Preferably, it is secure to ensure that all communications are free from tampering. To ensure that the data is secure, it is preferably encrypted. In exemplary embodiments, the uplink/downlink tool can provide at least some, preferably all, of the following types of traffic and/or functions:

1. Authenticating the student user's legitimate use of the RCTSM (such as, e.g., checking user IDs and/or passwords);

2. Updating the course content on the RCTSM (preferably, this is performed offline when the unit is not in use by the student);

3. Sending data captured to the instructor (such as, e.g., transmitting such data to the instructor's computer and/or to a central server in a manner that is accessible by the instructor [e.g., via an Internet Web Site or the like]).

Phase 4 (Virtual Reality Training Simulation Module)

In some exemplary embodiments, during this phase, three-dimensional (3D) modeling techniques can be employed to help teach certain subject matter. At this phase, the student is preferably more accustomed to the system technology (since the student has preferably, in certain embodiments, already completed one or more, preferably all, of phases 1-3). In this phase, the system can preferably be used entirely or substantially without an instructor's instruction.

In some exemplary embodiments, the user can register for the class on-line, such as, e.g., via the Internet. Preferably, the student is provided with a user identification (user ID) and a password (e.g., these can be provided via e-mail or via a secure Web Page). Preferably, when the student uses the virtual reality training simulation module (TSM), the student's information will be authenticated. At which time, they can access course materials they are properly registered for.

In some embodiments, the student can initially select his/her own level and as the student progresses through the course levels, the path of learning will change depending on their knowledge and capabilities due to an adaptive nature of the system. Preferably, the progress of the student can be monitored remotely by an instructor. Preferably, the instructor can also provide feedback to the system (such as, e.g., the central server and/or the student's individual machine) to accommodate for circumstances, such as, e.g., any faults in software or the like.

In some embodiments, because 3D modeling techniques provide a more life like environment, it can be possible to create a more realistic environment to teach some difficult subjects. For example, subjects having atypical (such as, e.g., non-local) auditory and/or visual features which are unfamiliar and non-accessible for direct observation, such as, e.g., cultural studies (such as, e.g., related to the Middle East or other regions), war scenario studies, etc., can be advantageously studied with such a system. Additionally, because the student is safe in this 3D environment, a student user can experience different things that would otherwise be dangerous in a real world environment. In this regard, in some embodiments, the student's device can include a game controller (such as, e.g., a joy stick) that manipulates a scene (image), etc., viewed by a virtual individual, simulating walking around in such an environment. Additionally, other 3D virtual devices can be included, such as, e.g., 3D mask/goggle displays worn over a user's eyes, sensory gloves and/or other devices to sense user movements, etc., as known in the art.

In some illustrative examples, a common server can be connecting via a network or the like to a plurality of student machines. The student machines can be programmed to transmit audio and/or video data to the central server. Then, the central server can be programmed to display an on-line or virtual meeting place (such as, e.g., showing visual images of the students, showing fictional characters operated by the students and/or the like). In this manner, the students can access an on-line meeting place to collaborate on certain training lessons, to perform certain tasks, to study together for lessons, exams or the like, and/or where they can talk to each other and carry out various conversations (e.g., in real time). In some exemplary embodiments, an instructor can have the ability to enter this virtual meeting place to interact with the students in a similar manner. In some embodiments, the instructor's identity may be made known to the students. In some embodiments, the instructor's identity may be made unknown and hidden from the students. For example, in some embodiments, the instructor can be inconspicuous and can teach by interacting with the students (such as, e.g., similar to other students and/or similar to other components of the programming) instead of being a regular instructor. In some embodiments, an instructor can also observe and/or grade the students as if he is in a 3D virtual chat room. In order to create such a virtual meeting place, existing 3D modeling programs, voice recognition software (optional), gaming technology and audio/visual technology can be employed.

### Illustrative Training System Embodiments

In some illustrative embodiments, the training system can include a Web based application, such as, e.g., a three-tier Web based application. In some illustrative and non-limiting embodiments, the application can be developed using, e.g., J2EE technologies based on JRUN application server and MySQL database, MICROSOFT ACCESS SQL 2000 (e.g., as a database development tool), JAVA, MS VISUAL STUDIO.NET and/or ASP programming. In exemplary embodiments, as described above, the application program files are preferably stored locally on student computers (rather than being accessed remotely via student computers that access a remote server as in common three-tier Web based applications over the Internet).

In some exemplary embodiments, the system includes a multitude of lessons (such as, e.g., about 20 lessons [of, e.g., about 30 minutes to 1.5 hours] in some illustrative examples) divided into sub-modules (such as, e.g., about 4 sub-modules in some illustrative examples). By way of example, in a language training course, a module 1 may focus on grammar skills, a module 2 may focus on reading skills, a module 3 may focus on listening skills, and a module 4 may focus on speaking skills. In exemplary embodiments, the system presents text, images, audio and video contents to students to provide a richer learning experience for students.

In some embodiments, a Java sound applet or other programming can be used to enable students to record their voices and then play back the recording to hear their own voices (such as, e.g., to help develop pronunciations in language studies). In some embodiments, a variety of exercises can be presented to students (such as, e.g., in some embodiments, students can be provided with different kinds of exercises so that students can practice their language skills in grammar, reading, writing, listening and/or speaking).

In some embodiments, students can submit written answers and/or written exercises that can be stored in a database or the like (such as, e.g., via JDBC connectivity) once the students submits the answers and/or written exercises, such as, e.g., by clicking a “Submit” button.

In some embodiments, an instructor tracking system is provided that enables instructors to track students' exercises. In some embodiments, the tracking system enables the identification of the time each student spends on course materials, such as, e.g., lessons, units, pages or the like (such as, e.g., the entering time and/or the leaving time and/or the total time each student is at each page of a course).

In exemplary embodiments, the system enables students to easily navigate through different parts of the courses. In this regards, in some embodiments, each of the Web Pages presented to a student user in a specific course preferably incorporates a plurality of substantially consistent features, including, e.g., one or more, preferably all, of the following:

Image icons that each link to a particular first page of a respective one of the modules.

One or more, preferably, all of the following arrow icons that link to one of the following: a previous module (which can, e.g., load the first page of the previous module when the arrow is clicked); a next module (which can, e.g., load the first page of the next module when the arrow is clicked); a previous lesson (which can, e.g., load the first page of the previous lesson when the arrow is clicked); a next lesson (which can, e.g., load the first page of the next lesson when the arrow is clicked); a previous page; and a next page.

An image icon that links to a “table of contents” page.

In some embodiments, a link's text hint on each of the above-mentioned image icons can be automatically displayed when the image icon is rolled over.

An image icon that links to a pop-up window showing a “help” page that explains the usage of the above-mentioned icons or the like.

An image icon that links to the window's “exit” function.

In some embodiments, the screen display can include icons linked to initiate sound recording or the like functionality, such as, e.g., one or more of the following features:

Record your voice: In which a student can record his/her voice by clicking on this button.

Play the recording: In which a student can play the recording by clicking on this button. * Pause the current action: In which a student can pause recording or playback by clicking on this button.

Resume the previous action: In which a student can resume recording or playback by clicking on this button.

Stop the current action: In which a student can stop recording or playback by clicking on this button.

In some embodiments, the screen display can include icons linked to initiate audio playback or the like functionality (such as, e.g., to listen to the pre-recorded class using an audio control bar), such as, e.g., one or more of the following features:

Play the audio: Play and listen to the audio by clicking on this button.

Pause the playing of the audio: Pause the playing of the audio by clicking on this button (preferably, the audio will continue from the pause if a Play button is clicked).

Stop the playing of the audio: Stop the playing of the audio by clicking the button (preferably, the audio will play from the beginning if the Play button is clicked).

In some embodiments, the screen display can include icons linked to initiate video playback or the like functionality (such as, e.g., to watch a pre-recorded class video using a video control bar), such as, e.g., one or more of the following features:

Play the video: Play and watch the video by clicking on this button.

Pause the playing of the video: Pause the playing of the video by clicking on this button (preferably, the audio will continue from the pause if a Play button is clicked).

Stop the playing of the video: Stop the playing of the video by clicking the button (preferably, the video will play from the beginning if the Play button is clicked).

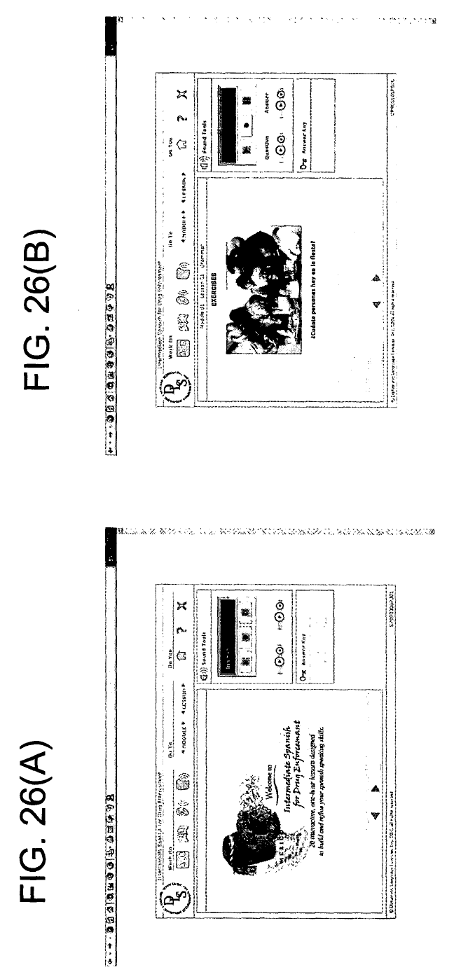

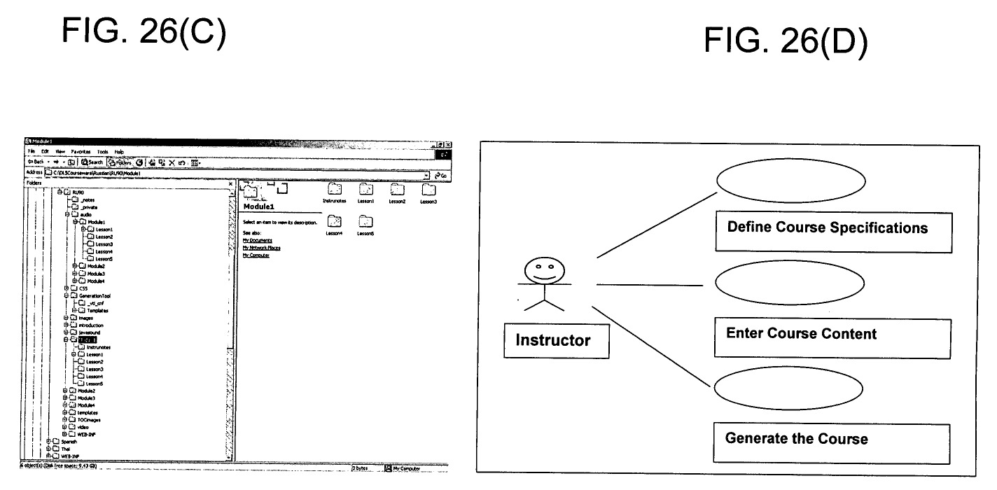

FIG. 26(A) shows an illustrative welcome page of an illustrative course entitled “Intermediate Spanish for Drug Enforcement.” FIG. 26(B) shows an illustrative page of the illustrative course shown in FIG. 26(A) showing common page features with particular subject matter related to grammar.

### Illustrative Content Generation Tool Embodiments

In some exemplary embodiments, as discussed above, a content generation tool (CGT) is provided. In some embodiments, the content generation tool can be created using, e.g., MICROSOFT ACCESS, MICROSOFT ACCESS SQL 2000 [as a database development engine] and/or other software applications for the development of a new web-based course for language.

Illustrative Operation Procedures of the Content Generation Tool

In some exemplary embodiments, the content generation tool can be involved in at least the following two operation procedures:

1. Insertion of Course Content into a Database

In some embodiments, using a form (such as, e.g., a MICROSOFT ACCESS, MICROSOFT ACCESS SQL 2000 [as a database development engine] or the like form or the like) entitled, e.g., ‘EnterCourseContent’, an instructor can directly enter the course content and other related data on, e.g., a page-by-page basis that will then be inserted into a database table entitled, e.g., ‘CourseContent’, in which each record stores the course content and other data required for a single Web Page in the course.

2. Generation of all the Web Pages for a Course

In some embodiments, when a command button on another form (such as, e.g., a MICROSOFT ACCESS, MICROSOFT ACCESS SQL 2000 [as a database development engine] or the like form or the like) entitled, e.g., ‘GenerateWholeCourse’ is clicked, the event handler of the tool will perform the “repeating loop” operations to automatically generate all files (e.g., JSP files and the like) for a course one at a time. In some exemplary embodiments, in each loop of the operations, an event handler will process one record of data in the ‘CourseContent’ table by performing, e.g., some or all of the following actions: (1) extracting all the fields' values from the record; (2) reading one of a plurality of template files depending on the value of a ‘template’ field at the record, and then replacing the variables embedded in the ‘template’ file with values of the corresponding fields at the record; (3) assigning a JSP file name to a newly generated page depending on values of the module, lesson and page fields, and then writing the JSP file into a target directory in a pre-established system directories hierarchy. In some exemplary embodiments, the “repeating loop” operations will end once the last record in the ‘CourseContent’ table has been processed. In some illustrative embodiments, a variety of kinds of templates can be developed (nineteen illustrative templates are described below) which can, e.g., provide a variety of Web Page formats in which the text, image, audio and/or video course content, etc., can be presented.

Illustrative Components of a Content Generation Tool

In some embodiments, the CGT includes programming that can be loaded and run on an instructor's computer and/or on a central server that is adapted to receive text, image and/or audio data from a remote instructor computer, such as, e.g., using TCP/IP, UDP, and/or other communication protocols over the Internet. For example, the CGT may create a Web Page interface that can be accessed by an instructor or the like from a remote instructor computer (such as, e.g., upon entry of appropriate user ID and/or password). The content generation tool, thus, preferably involves a two-tier system. In some exemplary embodiments, the CGT can include one or more of the following components.

Front-End Graphic User Interfaces

In exemplary embodiments, the CGT includes a front end graphical user interface. In some embodiments, the interface(s) can include a plurality of forms for entering information. In some embodiments, one or more, preferably all of the following forms (which can be created using a database management tool, such as, e.g., MICROSOFT ACCESS, MICROSOFT ACCESS SQL 2000 [as a database development engine] or the like) can be employed.

1. Switchboard form: This form preferably serves as the ‘Home’ or ‘Central Control’ form for this tool and provides navigation buttons leading to other forms, such as: a ‘DefineCourseSpecifications’ form, an ‘EnterCourseContent’ form and a ‘GenerateWholeCourse’ form.

2. DefineCourseSpecifications form: This is a form that is preferably used to set the major specifications for a new course including, for example, one or more of the following: course's unit ID; course name; language; path to templates under which template files are stored; path to course root under which all the course related files are stored; maximum module number; and/or maximum lesson number.

3. EnterCourseContent form: This is a form that is preferably used for an instructor to enter the course content and other required data that will then be inserted, in some illustrative embodiments, into a table of the database on a page-by-page basis.

4. GenerateWholeCourse form: This is a form that is preferably used to generate and store all the files (e.g., JSP files or the like) for a specific course in a pre-established system directory hierarchy.

Back-End Database

In exemplary embodiments, a back-end database is created. The database preferably resides on the central server. The database is preferably built using MICROSOFT ACCESS, MICROSOFT ACCESS SQL 2000 [as a database development engine] or the like. In some illustrative embodiments, the database can include at least some of the following tables:

1. Switchboard Items table: This is a table that preferably stores the data necessary for the Switchboard form's control operations.

2. CourseSpecifications table: This is a table that preferably stores the data on a course's specifications.

3. CourseContent table: This is a table that preferably stores the course content and other related date required for generating a new course. In this table, each record (e.g., row) preferably contains the course content for a single web page in the course.

4. ContentinTable table: This is a table that preferably stores those course contents that will be displayed within a HTML table in a web page. Note: A sub-form is preferably imbedded in the Template 16 sub-form (discussed below). By using this sub-form, instructors can enter the course contents in a datasheet. The column number can vary, e.g., from two to six depending on the course requirements.

5. Templates table: This is a table that preferably stores the data regarding all the available template files.

Pre-Established System Directory Hierarchy

In some embodiments, a pre-established system hierarchy tool is provided. This tool is preferably used in conjunction with a pre-established system directory hierarchy in which course-related files with file extensions such as .html, .jsp, .gif, .jpeg, .wav, .css, .mpg, .swf, .asp, .avi, .pdf, .doc, .xls, .ppt, etc. will be stored. Preferably, both the Courseware Content Generation Tool and the above-mentioned system directory hierarchy are stored in a local disk drive of an instructor's computer prior to the development of a new course. FIG. 26(C) shows a sample of a pre-established system directory hierarchy.

Use Case Models for the Content Generation Tool

In some embodiments, the CGT is developed on the basis of a use case model represented by three use cases described below and illustrated in the user case model shown in FIG. 26(D).

Use Case 1: Define Course Specifications

In some embodiments, the sequences of actions in this use case to be executed on, e.g., the ‘DefineCourseSpecifications’ form can include:

1. Clicking the ‘Define Course Specifications’ button on the ‘Switchboard’ form to open the ‘DefineCourseSpecifications’ form.

2. Entering the course's unit ID in a ‘Unit’ text field.

3. Entering the course name in a ‘Course Name’ text field.

4. In examples involving language instruction, entering the instructed language name in a ‘Language’ text field.

5. Clicking a ‘Select’ button next to a ‘Path to Templates’ text field to open a ‘Browse’ window. Then, browsing the system directories to find the directory under which template files are stored. The whole template directory path will preferably be automatically entered into the ‘Path to Templates’ text field when an ‘OK’ button is clicked.

6. Clicking a ‘Select’ button next to a ‘Path to Course Root’ text field to open a ‘Browse’ window. Then, browsing the system directories to find the Course Root directory. The whole course root directory path will preferably be automatically entered into the ‘Path to Course Root’ text field when an ‘OK’ button is clicked.

7. Entering a ‘Maximum Module Number’ text field (which can, e.g., default to a value, such as, e.g., 4 in some embodiments).

8. Entering a ‘Maximum Lesson Number’ text field (which can, e.g., default to a value, such as, e.g., 5 in some embodiments).

9. Clicking a ‘Save Record’ button to save the record in the ‘CourseSpecifications’ table.

10. Clicking a ‘Close Form’ to close the form.

Use Case 2: Entering Course Content

In some embodiments, this use case can be used through the ‘EnterCourseContent’ form to perform the four tasks as follows.

1. Entering Course Content

In some embodiments, the sequences of actions to be executed on the ‘EnterCourseContent’ form can include, for example:

a. Clicking the ‘Enter Course Content’ button on the ‘Switchboard’ form to open the ‘EnterCourseContent’ form.

b. Clicking ‘Record’ navigation arrows (such as, e.g., at a bottom of the form or the like) to open a new form.

c. Clicking a downward arrow on the ‘Select Template’ list box to select one of a plurality of templates (such as, e.g., one or more of nineteen templates described below in some illustrative embodiments) to be used for the generation of the current page. As a result of the template selection's event, a sub-form with the selected template name as its Tab name will preferably be created at the lower section of the ‘EnterCourseContent’ form.

d. Clicking a ‘Display Template’ button so as to confirm whether the template is a right choice (such as, e.g., to pop up a browser window that displays a sample page of the selected template).

e. Entering a module number, a lesson number and a page number in a ‘Module’, ‘Lesson’ and ‘Page’ text fields, respectively. As a result of the data change events occurring at the above three text fields, all the text fields on the ‘General’ sub-form will preferably be automatically loaded with corresponding data by three event handlers coded with VISUAL BASIC for applications (VBA) or the like.

f. Entering a page title for the current page in a ‘Page Title’ text field.

g. Entering a concise name (such as, e.g., one or two words) for the current page in the ‘Page Name’ text field.

h. Clicking a Tab with its name as the template name selected from Step 3 to open a sub-form that designed according to the format of the selected template (discussed below).

i. Entering all of the course content and other required data on the template's sub-form following the instructions given below under “Entering the Course Content Using a Template Sub-form.”

j. Clicking the ‘Record’ navigation arrows at the bottom of the form to open a new form to continue entering the course content for another page. At the same time, any updates on a previous form can be automatically stored in the database.

k. Clicking the ‘Return to Home’ button to open the ‘Switchboard’ form or clicking the ‘Close Form’ button to close the form.

2. Deleting a Record

In some embodiments, to delete a record from the database (e.g., to delete a page from the course), the sequences of actions to be executed on the ‘EnterCourseContent’ Access form include:

a. Clicking the ‘Enter Course Content’ button on the ‘Switchboard’ form to open the ‘EnterCourseContent’ form.

b. Clicking the ‘Record’ navigation arrows (such as, e.g., at the bottom of the form) to search for the form whose corresponding record in the database needs to be deleted.

c. Clicking a ‘Delete Record’ button (such as, e.g., at a lower section of the form) to delete the current record from the ‘CourseContent’ table. Preferably, as a result of the on-click event, the page numbers of all the following pages in the same Module/Lesson will automatically be decreased by 1 and these updates will be stored in the ‘CourseContent’ table.

3. Inserting a Record

In some embodiments, to insert a new record into a middle of the ‘CourseContent’ table (such as, e.g., to insert a new page into a module and/or lesson), the sequences of actions to be executed on the ‘EnterCourseContent’ form can include:

a. Performing the actions from Step a to Step i listed above in Part I: Enter Course Content.

b. Clicking an ‘Insert Record’ button (such as, e.g., at a lower section of the form) to insert the current record into the ‘CourseContent’ table. As a result of the on-click event, the page numbers of all the following pages in the same module and/or lesson will automatically be increased by 1 and these updates will be stored in the “CourseContent” table.

4. Updating a Record

In some embodiments, if a record needs to be updated in the ‘CourseContent’ table (such as, e.g., if a page is to be modified), the sequences of actions to be executed on the ‘EnterCourseContent’ form can include:

a. Clicking the ‘Enter Course Content’ button on the ‘Switchboard’ form to open the ‘EnterCourseContent’ form.

b. Clicking the ‘Record’ navigation arrows (such as, e.g., at a bottom of the form) to search for the form whose corresponding record in the database needs to be updated.

c. Making the necessary modifications on the form.

d. Clicking the ‘Record’ navigation arrows (such as, e.g., at the bottom of the form) to move either forward or backward. Preferably, at the same time, any updates on the form will be automatically stored in the database.

Use Case 3: Generating Course

In some embodiments, the sequences of actions in this use case to be executed on the ‘GenerateWholeCourse’ form can include:

1. Clicking the ‘Generate Whole Course’ button on the ‘Switchboard’ form to open the ‘GenerateWholeCourse’ form.

2. Clicking the ‘Create Course’ button to generate and store all of the files (e.g., JSP files and the like) for a course in the pre-established local system directories.

3. Clicking the ‘Close Form’ button to close the form.

Entering the Course Content Using a Template Sub-Form

In some embodiments, template forms can be used. A variety of illustrative and non-limiting forms are set forth below.

Template 1:

This illustrative template can be used to create a page in which one or more paragraphs of text are presented. In some illustrative embodiments, to enter course content and other related data, a user can perform the following sequences of actions on the template's sub-form.

1. Entering or copying & pasting the text in the ‘Text Content’ text area.

2. Entering ‘<br>’ or the like at the end of each line or paragraph of text (such as, e.g., to identify a new line or paragraph).

3. Entering a maximum number of lines of text (such as, e.g., between about 20-25 lines) in each ‘Text Content’ text area. Creating a new page if the current page can not contain the whole text.

Template 2:

This illustrative template can be used to create a page in which an image, one or more sentences about the image and an audio are presented. Preferably, the audio will play a statement about the image when a ‘Play’ button on an audio control bar is clicked. In some illustrative embodiments, to enter course content and other related data, a user can perform the following sequences of actions on the template's sub-form.

1. Selecting Image File: Clicking ‘Select’ button to open the ‘Browse’ window. Then, browsing the system directories and selecting the target image file whose name will be automatically entered into the ‘Image File’ text field.

2. Entering one or more sentences about the image in the ‘Image Text’ text field.

3. Selecting Audio File: Clicking ‘Select’ button to open the ‘Browse’ window. Then, browsing the system directories and selecting the target audio file whose name will be automatically entered into the ‘Audio File’ text field.

Template 3:

This illustrative template can be used to create a page in which an image, one or more sentences about the image and two audios are presented. In some embodiments, the first audio will play a question about the image when the ‘Play’ button on the first Audio control bar is clicked. In some embodiments, the second audio will play the answer to the question when the ‘Play’ button on the second Audio control bar is clicked. In some illustrative embodiments, to enter course content and other related data, a user can perform the following sequences of actions on the template's sub-form.

1. Selecting Question Audio File: Clicking ‘Select’ button to open the ‘Browse’ window. Then, browsing the system directories and selecting the target audio file whose name will be automatically entered into the ‘Question Audio File’ text field.

2. Selecting Answer Audio File: Clicking ‘Select’ button to open the ‘Browse’ window. Then, browsing the system directories and selecting the target audio file whose name will be automatically entered into the ‘Answer Audio File’ text field.

3. Selecting Image File: Clicking ‘Select’ button to open the ‘Browse’ window. Then, browsing the system directories and selecting the target image file whose name will be automatically entered into the ‘Image File’ text field.

4. Entering one or more sentences about the image in the ‘Image Text’ text field.

Template 4:

This illustrative template can be used to create a page in which a question text and two audios are presented. In some embodiments, the first audio will play the question when the ‘Play’ button on the first audio control bar is clicked. In some embodiments, the second audio will play the answer to the question when the ‘Play’ button on the second Audio control bar is clicked. In some illustrative embodiments, to enter course content and other related data, a user can perform the following sequences of actions on the template's sub-form.

1. Selecting Question Audio File: Clicking ‘Select’ button to open the ‘Browse’ window. Then, browsing the system directories and selecting the target audio file whose name will be automatically entered into the ‘Question Audio File’ text field.

2. Select Answer Audio File: Clicking ‘Select’ button to open the ‘Browse’ window. Then, browsing the system directories and selecting the target audio file whose name will be automatically entered into the ‘Answer Audio File’ text field.

3. Entering the ‘Question Text’ text field.

Template 5:

This illustrative template can be used to create a page in which a sentence of text for a question and a text field for collecting a student's one-sentence answer/exercise are presented. In some illustrative embodiments, to enter course content and other related data, a user can perform the following sequences of actions on the template's sub-form.

1. Entering the ‘Question ID’ text field.

2. Entering the ‘Question Text’ text field.

Template 6:

This illustrative template can be used to create a page in which a sentence of text (such as, e.g., in English) for a question and an audio are presented. The audio can play, e.g., a translated sentence in an instructed language when the ‘Play’ button on the Audio control bar is clicked. In some illustrative embodiments, to enter course content and other related data, a user can perform the following sequences of actions on the template's sub-form.

1. Entering the ‘Question Text’ text field.

2. Selecting Answer Audio File: Clicking ‘Select’ button to open the ‘Browse’ window. Then, browsing the system directories and selecting the target audio file whose name will be automatically entered into the ‘Answer Audio File’ text field.

Template 7:

This illustrative template can be used to create a page in which a sentence of text for a question and a text box used to collect a student's answer/exercise with a small paragraph are presented. In some illustrative embodiments, to enter course content and other related data, a user can perform the following sequences of actions on the template's sub-form.

1. Entering the ‘Question ID’ text field.

2. Entering the ‘Question Text’ text field.

Template 8:

This illustrative template can be used to create a page in which a multiple-choice question is presented. In some illustrative embodiments, to enter course content and other related data, a user can perform the following sequences of actions on the template's sub-form.

1. Entering the ‘Question ID’ text field.

2. Entering the ‘Question Text’ text field.

3. Entering the last N (where N=a number, such as, e.g., 4) text fields for N choices of the answers, respectively.

Template 9:

This illustrative template can be used to create a page in which an audio and a multiple-choice question are presented. In some embodiments, the audio will play a paragraph/dialogue when a ‘Play’ button on an audio control bar is clicked. The multiple-choice question is based on the content of the audio file. In some illustrative embodiments, to enter course content and other related data, a user can perform the following sequences of actions on the template's sub-form.

1. Entering the ‘Question ID’ text field.

2. Selecting Audio File: Clicking a ‘Select’ button to open the ‘Browse’ window. Then, browsing the system directories and selecting the target audio file whose name will be automatically entered into the ‘Audio File’ text field.

3. Entering the ‘Question Text’ text field.

4. Entering the last N (where N=a number, such as, e.g., 4) text fields for N choices of the answers respectively.

Template 10:

This illustrative template can be used to create a page in which a subtitle followed by instruction text and an audio are presented. In some embodiments, the audio will play a paragraph/dialogue (such as, e.g., in an instructed language) when the ‘Play’ button on the Audio control bar is clicked. In some illustrative embodiments, to enter course content and other related data, a user can perform the following sequences of actions on the template's sub-form.

1. Entering the ‘Sub Title’ text field.

2. Entering the ‘Instruction Text’ text field.

3. Selecting Audio File: Clicking ‘Select’ button to open the ‘Browse’ window. Then, browsing the system directories and select the target audio file whose name will be automatically entered into the ‘Audio File’ text field.

Template 11:

This illustrative template can be used to create a page in which a subtitle, an audio and two active links capable of generating two separate pop-up windows are presented. In some embodiments, the audio can play a paragraph and/or dialogue (e.g., in an instructed language) when the ‘Play’ button on the Audio control bar is clicked. A pop-up window showing the audio script (such as, e.g., in an instructed language) can be generated when an Answer Key icon (such as, e.g., for the language) is clicked. In some embodiments, a pop-up window (e.g., showing the audio script's English translation) can be generated when an certain Answer Key icon (e.g., for English) is clicked. In some illustrative embodiments, to enter course content and other related data, a user can perform the following sequences of actions on the template's sub-form.

1. Entering the ‘Sub Title’ text field.

2. Selecting Audio File: Clicking ‘Select’ button to open the ‘Browse’ window. Then, browsing the system directories and selecting the target audio file whose name will be automatically entered into the ‘Audio File’ text field.

3. Selecting the Instructed Language's Script File: Clicking ‘Select’ button to open the ‘Browse’ window. Then, browsing the system directories and selecting the HTML file that contains the audio script in the instructed language.

4. Selecting English Script File: Clicking ‘Select’ button to open the ‘Browse’ window. Then, browsing the system directories and selecting the HTML file that contains the audio script's English translation.

5. If necessary, modifying the default values of ‘Pop-Up Window Width’ and ‘Pop-Up Window Height’ in line with the requirements.

Template 12:

This illustrative template can be used to create a page in which an instruction text, two audios and two active links capable of generating two separate pop-up windows are presented. In some embodiments, the first audio will play a paragraph/dialogue (such as, e.g., in the instructed language) when the ‘Play’ button on the first Audio control bar is clicked. In some embodiments, the second audio will play the first audio's English interpretation when the ‘Play’ button on the second Audio control bar is clicked. In some embodiments, a pop-up window showing the audio script in the instructed language will be generated when the Answer Key icon for the language is clicked. In some embodiments, a pop-up window showing the audio script's English translation will be generated when the Answer Key icon for English is clicked. In some illustrative embodiments, to enter course content and other related data, a user can perform the following sequences of actions on the template's sub-form.

1. Selecting the Instructed Language's Audio File: Clicking ‘Select’ button to open the ‘Browse’ window. Then, browsing the system directories and selecting the target audio file whose name will be automatically entered into the ‘Instructed Language's Audio File’ text field.

2. Selecting English Audio File: Clicking ‘Select’ button to open the ‘Browse’ window. Then, browsing the system directories and selecting the target audio file whose name will be automatically entered into the ‘English Audio File’ text field.

3. Entering the ‘Instruction Text’ text field.

4. Selecting the Instructed Language's Script File: Clicking ‘Select’ button to open the ‘Browse’ window. Then, browsing the system directories and select the HTML file that contains the first audio's script in the instructed language.

5. Selecting English Script File: Clicking ‘Select’ button to open the ‘Browse’ window. Then, browsing the system directories and selecting the HTML file that contains the second audio script in English.

6. If necessary, modifying the default values of ‘Pop-Up Window Width’ and ‘Pop-Up Window Height’ in line with the requirements.

Template 13:

This illustrative template can be used to create a page in which a video is presented. In some embodiments, the video will be automatically played when the page is loaded. In some embodiments, the video will also be played when the ‘Play’ button is clicked. In some illustrative embodiments, to enter course content and other related data, a user can perform the following sequences of actions on the template's sub-form.

1. Selecting Video File: Clicking ‘Select’ button to open the ‘Browse’ window. Then, browsing the system directories and selecting the target video file whose name will be automatically entered into the ‘Video File’ text field.

Template 14:

This illustrative template can be used to create a page in which a sentence of text for a question and a text area for collecting a student's answer/exercise in a large paragraph are presented. In some illustrative embodiments, to enter course content and other related data, a user can perform the following sequences of actions on the template's sub-form.

1. Entering the ‘Question ID’ text field.

2. Entering the ‘Question Text’ text field.

Template 15:

This illustrative template can be used to create a page in which an example of a sentence in the instructed language and its English translation are presented. In some illustrative embodiments, to enter course content and other related data, a user can perform the following sequences of actions on the template's sub-form.

1. Entering the ‘Example’ text field.

2. Entering the ‘Example Translation’ text field.

Template 16:

This illustrative template can be used to create a page in which one or more paragraphs of text followed by a table of text content are presented. In some embodiments, the table can contain up to six columns of content. In some illustrative embodiments, to enter course content and other related data, a user can perform the following sequences of actions on the template's sub-form.

1. Entering the ‘Text in Paragraph’ text area.

2. Entering ‘<br>’ at the end of each line or paragraph of text (such as, e.g., to identify a new line or paragraph).

3. Entering the ‘Content in the Form’ datasheet on the column-by-column, row-by-row basis.

4. Entering the ‘Number of Columns Used’ text field.

5. Entering the ‘Table Width in Percentage’ text field.

Template 17:

This illustrative template can be used to create a page in which one or more paragraphs of text (such as, e.g., in an instructed language) and an active link capable of generating a pop-up window are presented. In some embodiments, a pop-up window showing the text's translation (e.g., in English or the like) will be generated when the Answer Key icon for the translation language is clicked. In some illustrative embodiments, to enter course content and other related data, a user can perform the following sequences of actions on the template's sub-form.

1. Entering the ‘Text Content’ text area.

2. Selecting Translation File: Clicking ‘Select’ button to open the ‘Browse’ Window. Then, browsing the system directories and selecting the HTML file that contains the text's translation.

3. If necessary, modifying the default values of ‘Pop-Up Window Width’ and ‘Pop-Up Window Height’ depending on the requirements.

Template 18:

This illustrative template can be used to create a page in which an image and a multiple-choice question are presented. In some embodiments, the multiple-choice question is based on the image. In some illustrative embodiments, to enter course content and other related data, a user can perform the following sequences of actions on the template's sub-form.

1. Entering the ‘Question ID’ text field.

2. Entering the ‘Question Text’ text area.

3. Entering the following N (where N=a number, such as, e.g., 4) text fields for N choices of the answers, respectively.

4. Selecting Image File: Click ‘Select’ button to open the ‘Browse’ window. Then, browsing the system directories and selecting the target image file whose name will be automatically entered into the ‘Image File’ text field.

Template 19:

This illustrative template can be used to create a page in which a video and two active links capable of generating two separate pop-up windows are presented. In some embodiments, the video will play a short movie when the page is loaded or when the ‘Play’ button on a Video control bar is clicked. In some embodiments, a pop-up window showing the video script in an instructed language will be generated when the Answer Key icon for the language is clicked. In some embodiments, a pop-up window showing the video script's translation (such as, e.g., in English) will be generated when the Answer Key Icon for a translation language is clicked. In some illustrative embodiments, to enter course content and other related data, a user can perform the following sequences of actions on the template's sub-form.

1. Selecting Audio File: Clicking ‘Select’ button to open the ‘Browse’ window. Then, browsing the system directories and selecting the target video file whose name will be automatically entered into the ‘Audio File’ text field.

2. Selecting the Instructed Language's Script File: Clicking ‘Select’ button to open the ‘Browse’ window. Then, browsing the system directories and selecting the HTML file that contains the video script in the instructed language.

3. Selecting English Script File: Clicking ‘Select’ button to open the ‘Browse’ window.

Then, browsing the system directories and selecting the HTML file that contains the video script's English translation.

4. If necessary, modifying the default values of ‘Pop-Up Window Width’ and ‘Pop-Up Window Height’ in line with the requirements.

GUI of Content Generation Tool

In some exemplary embodiments, as discussed above, the CGT includes a graphical user interface having a plurality of forms, such as:

1. Switchboard form;

2. DefineCourseSpecifications form;

3. EnterCourseContent form; and/or

4. GenerateWholeCourse form.

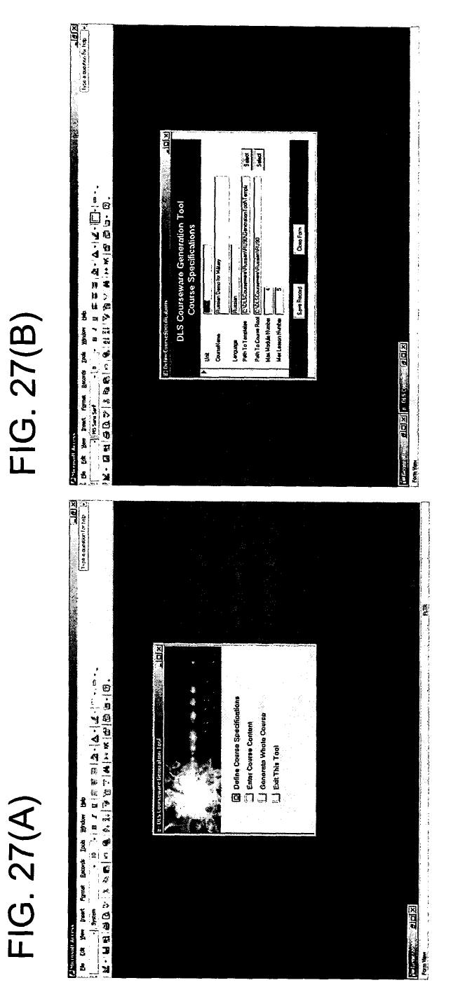

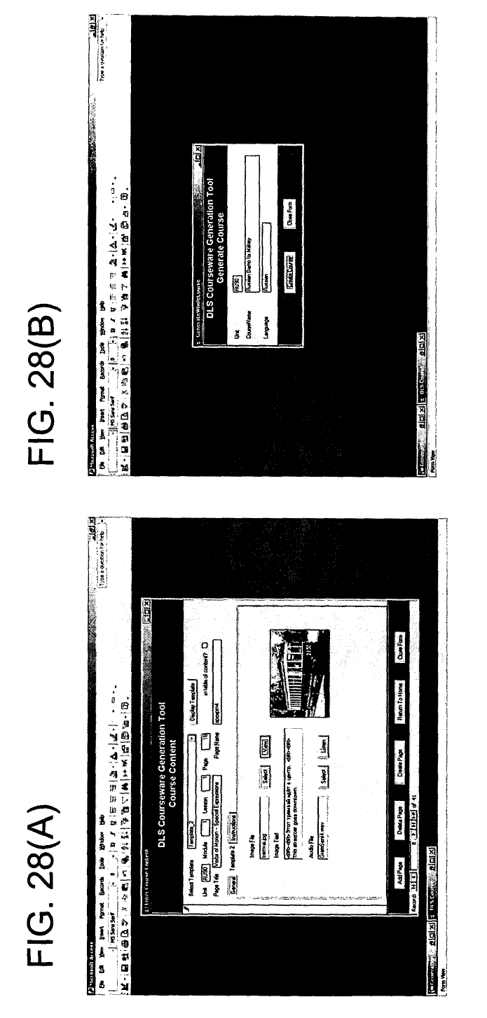

An illustrative switchboard form is shown in FIG. 27(A). An illustrative define course specifications form is shown in FIG. 27(B). An illustrative enter course content form is shown in FIG. 28(A). An illustrative generate whole course form is shown in FIG. 28(B).

### Other Exemplary CGI Tool Embodiments

In some exemplary embodiments, the content generation tool can include some or all of the features set forth below. In some embodiments, the tool can be designed based on a dynamic content library concept. In some preferred embodiments, it allows any basic course material (such as, e.g., a page, a lesson, a chapter, a subject, a topic and/or the like) to associate with a variety of learning objects (e.g., audio, video, web links, files, assessment/exams, etc.) for an optimal technology-based remote learning experience. In exemplary embodiments, the instructor can match each course unit with the most appropriate reference material, which the instructor can substantially continually or periodically update by uploading new learning objects (e.g., wherein each can be identified by its location, type and related course unit or the like).

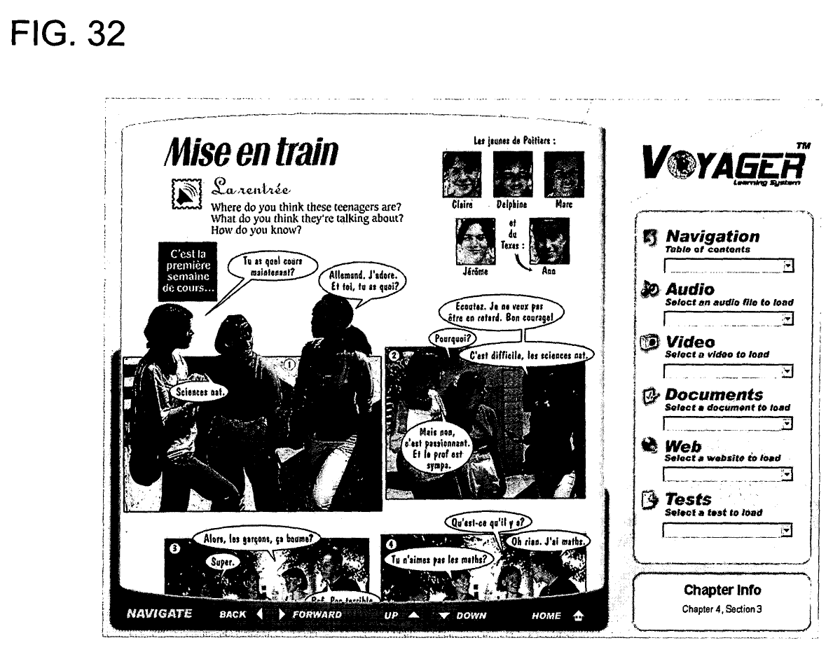

In this manner, remote learning classes can preferably thus be conducted using a standard courseware format (such as, e.g., a PDF format in some instances) with additional real-world/real-time relevant material being addable and/or customizable to suit each student's learning needs. In some embodiments, the content can reside in an on-site file server (e.g., owned or under the control of the training entity). In some other embodiments, however, such as, e.g., when systems are installed at client sites (such as, e.g., corporate client sites), at least some of the content (e.g., preferably that having the most bandwidth-intensive requirements) will be stored on the system installed at the client sites (such as, e.g., training module computers installed at the client site), with the rest being accessed from the training entity's nerve center (e.g., such as, e.g., the central server(s) shown in FIG. 1). An illustrative content display/upload design graphical user interface is shown in FIG. 32. For example, such a screen can be displayed to facilitate instructor insertion of content including, as shown, navigation buttons (as shown a drop down menu can be used to assist in navigation [such as, e.g., to various portions in a table of contents or the like), audio files (as shown a drop down menu can be used to select a desired type), video files (as shown a drop down menu can be used to select a desired type), documents (as shown a drop down menu can be used to select a desired type), web site URLs (this can include a drop down menu [of saved URLs, such as, e.g., favorites] or it can be typed in), tests to load (as shown a drop down menu can be used to select a desired test to load), and/or various other miscellaneous materials.

### Illustrative Instructor Tracking System Embodiments

In some exemplary embodiments, an instructor tracking system can include, e.g., a three-tier web based application. In some illustrative embodiments, the system can be developed using, e.g., J2EE technologies based on JRUN application server and MySQL database.

In exemplary embodiments, using this tracking system, instructors are preferably able to track their students' studying activities on the system, including students' exercises as well as the entering & leaving times, etc., when each student is at each page of a course.

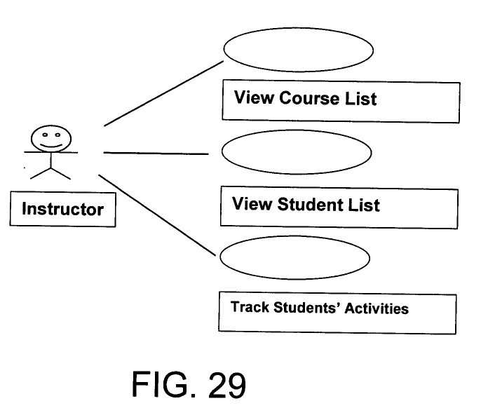

In some embodiments, this system can be developed on the basis of a use case model based on use cases as shown in FIG. 29.

Use Case 1: View Course List

In some exemplary embodiments, a view course list use case can be provided. In some embodiments, the sequences of actions in the use case to be executed can include, for example:

1. Opening an instructor's login page.

2. Signing-in to the instructor tracking system by entering an instructor's user ID and password. In some embodiments, if the instructor's account is validated by middle-layer web components, a ‘home page’ of the instructor tracking system will be loaded into the instructor's computer's browser window. Preferably, the home page will display a list of courses the instructor is currently teaching through the training system.

3. Viewing the course list.

Use Case 2: View Student List

In some exemplary embodiments, the sequences of actions in this use case to be executed can include, for example:

1. Clicking a button (such as, e.g., a radio button or the like) to select a course from a course list (such as, e.g., in an upper section) of the ‘home page.’

2. Clicking a button (such as, e.g., a radio button or the like) to select a student status (either current students or all students including graduated students) in the lower section of the ‘home page.’

3. Clicking a ‘submit’ button to load a ‘student list’ page that displays a list of students taking the course selected at step 1.

4. Viewing the student list.

Use Case 3: Track Students Activities

In some exemplary embodiments, a track students activities use case is provided. Preferably, this use case can include a plurality of parts.

1. Tracking Students' Studying Time

In some exemplary embodiments, the sequences of actions to be executed in this part can include:

a. Clicking a ‘studying time’ link corresponding to a student in a ‘student list’ page to load a ‘search studying time’ page.

b. Selecting a search date from a ’ display search results’ list box in the ‘search studying time’ page.

c. Selecting a module number from a ‘select module’ list box in the ‘search studying time’ page.

d. Selecting a lesson number from the ‘select lesson’ list box in the ‘search studying time’ page.

e. Clicking a ‘submit’ button to load a ‘search Results’ page.

2. Track Students' Exercises Containing Short Answers (E.G., One or Two Sentences)

In some exemplary embodiments, the sequences of actions to be executed in this part can include:

a. Clicking a ‘short exercises’ link corresponding to a student in a ‘student list’ page to load a ‘search exercises’ page.

b. Selecting a search date from a ’ display search results’ list box in a ‘search exercises’ page.

c. Selecting a module number from a ‘select module’ list box in the ‘search exercises’ page.

d. Selecting a lesson number from a ‘select Lesson’ list box in the ‘search exercises’ page.

e. Clicking a ‘submit’ button to load the ‘search results’ page.

3. Track Students' Exercises Containing Long Answers (E.G., Long Paragraphs)

In some embodiments, the sequences of actions to be executed in this part can include:

a. Clicking a ‘long exercises’ link corresponding to a student in the ‘student list’ page to load a ‘search exercises’ page.

b. Selecting a search date from a ’ display search results’ list box in the ‘search exercises’ page.

c. Selecting a module number from a ‘select module’ list box in the ‘search exercises’ page.

d. Selecting a lesson number from a ‘select lesson’ list box in the ‘search exercises’ page.

e. Clicking a ‘submit’ button to load the ‘search results’ page.

f. Clicking a ‘see answer’ link to load the page displaying the student's written paragraphs.

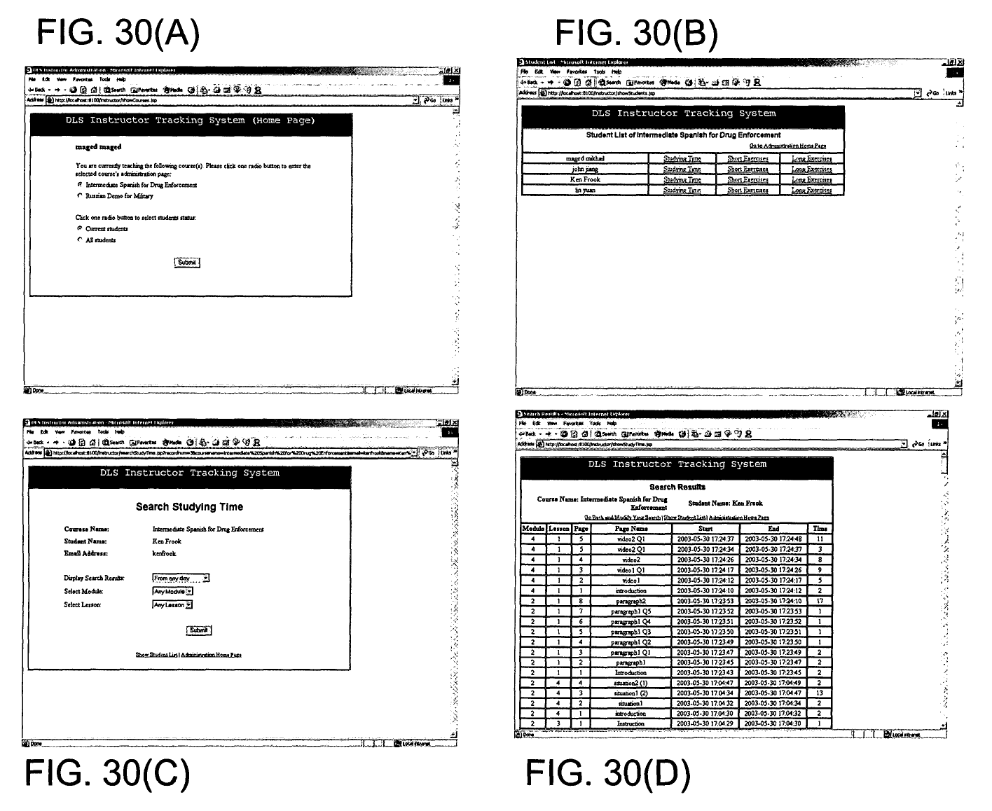

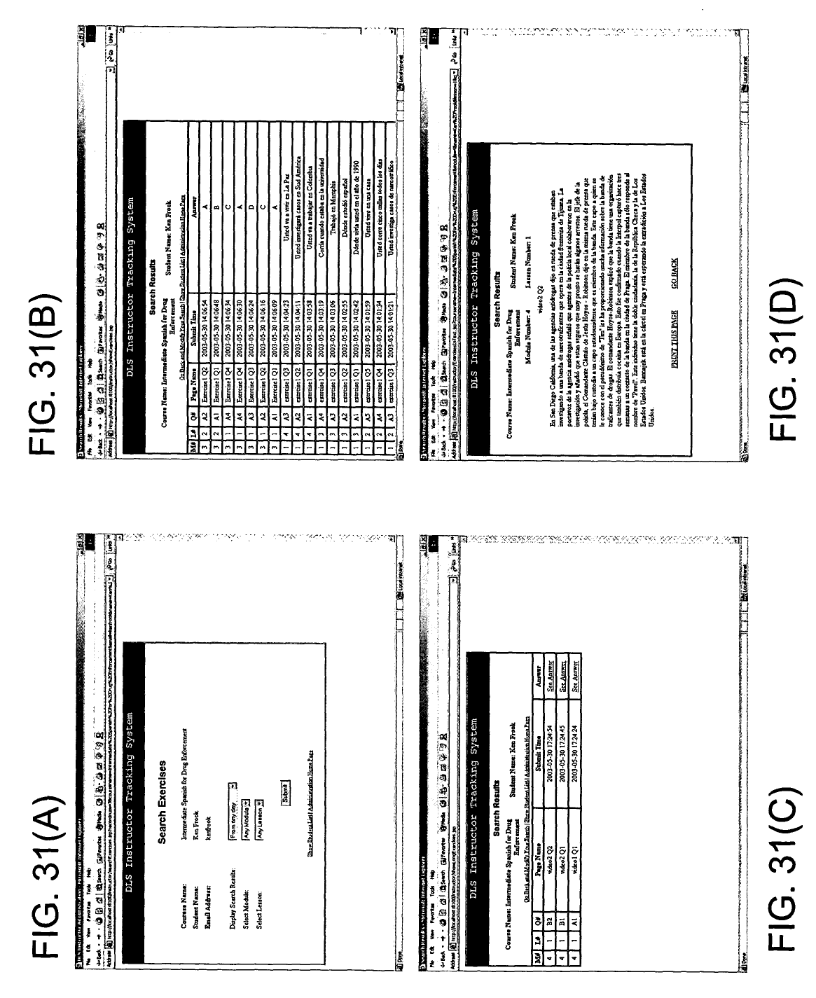

FIGS. 30(A)-30(D) and 31(A)-31(D) show some illustrative screen shots that can be displayed to an instructor using an illustrative embodiment of an instructor tracking system. In this regard, FIG. 30(A) shows an illustrative ‘home page,’ FIG. 30(B) shows an illustrative ‘student list’ page, FIG. 30(C) shows an illustrative ‘search studying time’ page, FIG. 30(D) shows an illustrative ‘search results for studying time’ page, FIG. 31 (A) shows an illustrative ‘search exercises’ page, FIG. 31(B) shows an illustrative ‘search results for short exercises’ page, FIG. 31(C) shows an illustrative ‘search results for long exercises’ page, and FIG. 31(D) shows an illustrative ‘search results for long exercise’ page with an illustrative student's answer.

Broad Scope of the Invention

While illustrative embodiments of the invention have been described herein, the present invention is not limited to the various exemplary embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure or step are not recited.

What is claimed is:

1. A training system, comprising:
a) a plurality of student computers configured to present course content to students;
b) at least one instructor computer networked with said plurality of student computers, said instructor computer and said plurality of student computers being configured to enable operation commands to be sent from said instructor computer to said student computer;
c) whereby, upon receipt of said operation commands, said student computers are modified and/or changed on said instructor commands;
d) said student computers and said at least one instructor computer each including audio and/or video receivers and transmitters to enable real time communication between the instructor and the student.

2. The training system of claim 1, wherein said student computers and said at least one instructor computer each include audio and video receivers and transmitters to enable real time audio and video communication between the instructor and the student.

3. The training system of claim 1, wherein said student computers enable the course content presented to the respective student to be modified based on said instructor commands

4. A training system, comprising:
a) a plurality of student devices, said student devices including course content stored thereon in digital data storage;
b) at least one instructor operable computer networked with said plurality of student devices, said instructor operable computer and said plurality of student devices being configured to enable operation commands to be sent from said instructor computer to said student devices;
c) whereby, upon receipt of said operation commands, said student devices enable the course content presented to the respective student to be modified based on said instructor commands.

5. The training system of claim 4, wherein said student devices are programmed to display course content to students without requiring a network communication over a public network and without requiring loading of software onto said devices due to pre-storage of said course content.

6. The training system of claim 4, further including student training module computers computer networked with said instructor operable computer.

7. The training system of claim 6, wherein said student training module computers are located on an on-site facility of a training entity operating the training system.

8. The training system of claim 1, wherein said course content includes lessons that are divided into a plurality of lesson units and wherein upon receipt of said operation commands, said student devices enable the course content presented to the respective student to modify the order of presentation of lesson units based on said instructor commands.

9. The training system of claim 4, further including a courseware generation tool module.

10. The training system of claim 9, wherein said courseware generation tool module is programmed in a central server that is accessed via said instructor operable computer.

11. The training system of claim 4, further including a student activity tracking tool module.

12. The training system of claim 11, wherein said student activity tracking tool module is programmed in a central server that is accessed via said instructor operable computer.

13. A training system, comprising:
a) a central server containing course management software;
b) a plurality of student devices, said student devices including course content downloadable from said central server;
c) at least one instructor operable computer networked with each of said plurality of student devices and said central server, said instructor operable computer and said plurality of student devices being configured to enable operation commands to be sent from said instructor operable computer to said student devices;
d) whereby, upon receipt of said operation commands, said student devices enable the course content presented to the respective student to be modified based on said instructor commands.

14. A multi-component training system, comprising:
a) a central server containing course management software;
b) a plurality of student computers;
c) at least some of said student computers including pre-programmed devices including course content downloaded from said central server;
d) at least some of said student computers being located in an on-site location;
e) at least some of said student computers being transported to a remote location distant to said on-site location;
f) whereby said student computers in d) and e) above can be used in different phases of student training.

15. The multi-component training system of claim 14, further including at least one instructor operable computer networked with each of said plurality of student computers and said central server, said instructor operable computer and said plurality of student computers being configured to enable operation commands to be sent from said instructor operable computer to said student devices, whereby, upon receipt of said operation commands, said student devices enable the course content presented to the respective student to be modified based on said instructor commands.

16. The training system of claim 14, wherein said student computers and said at least one instructor computer each include audio and/or video receivers and transmitters to enable real time communication between the instructor and the student.

17. The training system of claim 15, wherein said student computers and said at least one instructor computer each include audio and/or video receivers and transmitters to enable real time communication between the instructor and the student.

18. A method for facilitating instructor training of students, comprising:
a) having students access course content via a plurality of student computers configured to present course content to students;
b) modifying the course content presented to at least one student on at least one of said student computers based on commands sent from an instructor computer networked with said plurality of student computers;
c) having said at least one student communicate remotely with said instructor in substantially real time audio or video.

19. The method of claim 18, further including providing student computers and at least one instructor computer with audio and video receivers and transmitters to enable real time communication between the instructor and the student.

20. A method, comprising: controlling a course presentation to a remote student via a student computer by commands sent via a network from an instructor; and
conducting real life communication between the instructor and the student via audio and video communication.

21. The method of claim 20, wherein said controlling a course presentation and said conducting real life communications are carded out concurrently.

22. The method of claim 20, further including downloading an entire course presentation for a lesson in advance of a class or studying session so that data files are stored on said student computer.

23. The method of claim 20, further including distributing said student computer to said student in advance of an initial class date with course contents pre-loaded thereon.

24. The method of claim 20, further including tracking student activities on said student computer remotely by said instructor at an instructor computer via a tracking tool.

25. A course training console, comprising:
a) a computer system having a student console with a monitor for displaying course lesson information, wherein said course lesson information is pre-stored in digital data storage prior to displaying course lesson information;
b) said console including at least one audio/video receiver and transmitter configured to provide real time feedback from a remote instructor.

26. The course training console of claim 25, wherein said console includes a plurality of monitor sections.

27. The course training console of claim 26, wherein the console is configured to display reference material on a first monitor section, a video cam for conferencing at a second monitor section, and to display shared text communications at a third monitor section.

28. The course training console of claim 27, wherein the monitor sections include separate display screens.

29. A training system, comprising:
a) a plurality of student computers configured to present course content to students;
b) at least one instructor computer networked with said plurality of student computers, said instructor computer and said plurality of student computers being configured to enable operation commands to be sent from said instructor computer to said student computer;
c) wherein, upon receipt of said operation commands, said student computers are modified and/or changed on said instructor commands;
d) wherein said instructor commands modify and/or change at least two of said student computers differently.

30. The training system of claim 29, wherein said instructor commands enable and/or cause said student computers to interact with each other.

31. The training system of claim 29, wherein said student computers are arranged in console clusters, in which students sit facing non-parallel to one another in adjacent consoles.

32. The training system of claim 31, wherein said clusters are clusters of three or more consoles.

33. The training system of claim 29, wherein said student computers and said at least one instructor computer each includes audio and/or video receivers and transmitters to enable real time communication between the instructor and the student.

34. The training system of claim 29, wherein said instructor can send instructor command signals to one student.

35. The training system of claim 29, wherein the instructor can send command signals to a subset of students within a class.

36. The training system of claim 29, wherein the the instructor can send command signals to an entire group of students.
